(19) United States
(12) Patent Application Publication
(10) Pub. No.: US 2025/0092247 A1
(43) Pub. Date: Mar. 20, 2025

(54) ALKYLATED PHENOLIC RESIN COMPOSITIONS AND USES

(71) Applicant: Hexion Inc., Columbus, OH (US)

(72) Inventors: Lem GABREHIWET, Edmonton (CA); Shuna CHENG, Edmonton (CA); Gregory D. BRINER, Springfield, OR (US); Jason L. HOLDER, Diboll, TX (US)

(21) Appl. No.: 18/882,016

(22) Filed: Sep. 11, 2024

Related U.S. Application Data
(60) Provisional application No. 63/538,635, filed on Sep. 15, 2023.

(51) Int. Cl. C08L 61/12; C08K 5/053; C08L 91/06; D21H 17/06; D21H 17/48; D21H 17/60; D21J 1/08

(52) U.S. Cl. CPC C08L 61/12; C08K 5/053; C08L 91/06; D21H 17/06; D21H 17/48; D21H 17/60; D21J 1/08

(57) ABSTRACT

Embodiments of the present disclosure generally relate to phenolic resin compositions, methods for preparing the same, and uses thereof. In an embodiment, a resin composition is provided. The resin composition includes a wax emulsion and a polymer composition that includes an alkylphenol-phenol-aldehyde polymer, the alkylphenol-phenol-aldehyde polymer including: alkylphenol monomer units; and phenol compound co-monomer units. In another embodiment is provided an article of manufacture that includes a lignocellulosic substrate, and a resin composition that includes an alkylphenol-phenol-aldehyde polymer, a polyhydric alcohol, and a wax emulsion.

### CROSS-REFERENCE TO RELATED APPLICATIONS

This application claims benefit of and priority to U.S. Provisional Application Ser. No. 63/538,635, filed on Sep. 15, 2023, which is incorporated herein by reference in its entirety.

### FIELD

Embodiments of the present disclosure generally relate to phenolic resin compositions, methods for preparing the same, and uses thereof.

### BACKGROUND

Phenolic resins, such as phenol-aldehyde resins, are widely used as binders and adhesives in structural lignocellulosic composites such as oriented strand board (OSB), particle board, composite panels, and plywood. Phenolic resins are typically water-based, require loss of that water to cure, lack water resistance properties. As a consequence, conventional phenolic resins do not perform well in the production of lignocellulosic composites manufactured under high-moisture conditions or when steam pre-heated. Here, for example, the exposure to steam (forced steam air) dilutes the phenolic resin, causing the resin to over-penetrate the wood substrate, wash out, or both, and leads to the poor bonding between the resin and the wood substrate. High moisture and steam slows the curing process of phenolic resins and therefore the curing cycle time must be increased for the board to be cured and the increase in cycle time negatively impacts production rate and throughput. Dilution, over-penetration, and washing out also result in weakened physical properties of the composites. Here, for example, lignocellulosic composites fabricated from conventional phenolic resins suffer from high water absorption and thickness swell. The high water absorption and thickness swell can cause poor dimensional stability of the composites due to raised joints, buckling of panels, and unevenness. The poor mechanical stability of composites fabricated with conventional phenolic resins can also affect the composite's structural integrity and reduces the composite's load carrying ability.

There is a need for new phenolic resin compositions.

### SUMMARY

Embodiments of the present disclosure generally relate to phenolic resin compositions, methods for preparing the same, and uses thereof. Unlike conventional phenolic resins, embodiments described herein can be used with steam pre-heaters and in continuous steam processes without loss of line speed or final panel properties. In addition, phenolic resin compositions described herein can be fast curing resulting in no loss of manufacturing time. Further, in contrast to conventional phenolic resins, resin compositions of the present disclosure are capable of producing lignocellulosic composite products with superior water absorption and thickness swell test results, evidencing their superior mechanical performance. In addition, embodiments described herein can be used for moisture barrier applications without loss on final panel water properties.

In an embodiment, a resin composition is provided. The resin composition includes a wax emulsion and a polymer composition that includes an alkylphenol-phenol-aldehyde polymer, the alkylphenol-phenol-aldehyde polymer including: a wax emulsion; and a polymer composition comprising an alkylphenol-phenol-aldehyde polymer. The alkylphenol-phenol-aldehyde polymer includes alkylphenol monomer units and phenol compound co-monomer units, the alkylphenol monomer units represented by Formula (I):

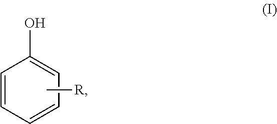

wherein R is an unsubstituted hydrocarbyl having from 1 to 40 carbon atoms or a substituted hydrocarbyl having from 1 to 40 carbon atoms

In another embodiment, a resin composition is provided. The resin composition includes a wax emulsion, and a polymer composition comprising a condensation product of a reaction mixture comprising an alkylphenol compound, a phenol compound, an aldehyde, a base, a polyhydric alcohol, and a solvent.

In another embodiment, a curable resin composition is provided. The curable resin composition includes a wax emulsion. The curable resin composition further includes a reaction product of: a phenol compound; formaldehyde; and an alkylphenol having from 1 to 40 carbon atoms in an alkyl group of the alkylphenol, wherein a molar ratio of the formaldehyde to total amount of the phenol and the alkylphenol is from about 2:1 to about 2.6:1.

In another embodiment is provided an article that includes a lignocellulosic material and a composition described herein.

In another embodiment, an article of manufacture is provided. The article of manufacture includes a lignocellulosic substrate, and a resin composition that includes an alkylphenol-phenol-aldehyde polymer, a polyhydric alcohol, and a wax emulsion.

In another embodiment, a resin composition is provided. The resin composition includes a wax emulsion; a phenolic resin; and a polymer composition comprising an alkylphenol-phenol-aldehyde polymer.

In another embodiment, an article of manufacture is provided. The article of manufacture includes a lignocellulosic substrate; and a resin composition comprising: an alkylphenol-phenol-aldehyde polymer; a phenolic resin; and a wax emulsion.

In another embodiment, a method of forming a resin composition is provided. The method includes heating a reaction mixture comprising two or more phenolic compounds, an aldehyde, a base, a polyol, and a solvent to form a polymer composition, wherein a first phenolic compound of the two or more phenolic compounds includes an alkylphenol having the formula:

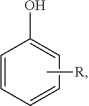

wherein R comprises 1 to 40 carbon atoms, and wherein the aldehyde is selected from the group consisting of formaldehyde, paraformaldehyde, and combinations thereof. The method further includes introducing a wax emulsion with the polymer composition to form the resin composition.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 shows an overlay of gel permeation chromatography (GPC) chromatograms of a high molecular weight alkylphenol-phenol-aldehyde polymer composition, a low molecular weight alkylphenol-phenol-aldehyde polymer composition, and a blend thereof.

FIG. 2 is a bar chart showing the components of a high molecular weight alkylphenol-phenol-aldehyde polymer composition, a low molecular weight alkylphenol-phenol-aldehyde polymer composition, and a blend thereof.

### DETAILED DESCRIPTION

Embodiments of the present disclosure generally relate to phenolic resin compositions, methods for preparing the same, and uses thereof. The inventors have found phenolic resin compositions that can overcome the many hurdles faced by conventional phenolic resins during the manufacture of lignocellulosic composites. Briefly, and in some embodiments, the phenolic resin compositions can include an alkylphenol-phenol-aldehyde polymer, a wax emulsion, and optionally one or more additives such as rheology modifiers.

As described above, conventional phenolic resins do not perform well in the production of lignocellulosic composites manufactured under high-moisture conditions or when steam pre-heated. Lignocellulosic composites, such as OSB, are typically produced by continuous presses that use steam pre-heaters to heat the mat and start the cure process in order to gain line speed and maximize production yield. While the moisture content (dew point) of the steam is low, it impacts the cure of the adhesive used to make the panel. Lignocellulosic composite manufactures running continuous press steam preheater processes typically rely on polymeric methylene diphenyl diisocyanate (pMDI) as an adhesive. During application of the steam, the hydrophobicity of pMDI helps prevent the adhesive from wash out, and the moisture present during such steam application helps pMDI, as an isocyanate, to cure faster. In contrast, exposing conventional phenolic resin adhesives to steam dilutes the resin, causing the resin to over-penetrate the lignocellulosic substrate, wash out, or both, and leads to the poor bonding between the resin and the lignocellulosic substrate.

In order to, for example, enhance properties of phenolic resins, the inventors found that partial replacement of phenol in a phenol-aldehyde resin results in an alkylphenol-phenol-aldehyde resin having improved hydrophobicity properties, improved surface tension for better surface area coverage (resin distribution), and improved wetting properties. In some examples, it was found that alkylphenol-phenol-aldehyde resins having reduced amounts of smaller molecular species (for example, methylolated phenols) and increased amounts of oligomers, intermediate polymers, large polymers, and very large polymers can have better properties. Here, ratios of aldehyde to phenol/alkylphenol and/or amounts of catalyst (for example, sodium hydroxide) can be controlled to achieve, for example, the desired types of linkages, polydispersity, and polymer molecular weight distribution between the monomers (for example, formaldehyde, phenol, and alkylphenol) to balance reactivity and cure speed.

The inventors also found that a phenolic resin composition that includes a wax emulsion (for example, sodium lignosulfonate slack wax) can improve the water properties without impacting bonding and durability of the finished lignocellulosic composite, e.g., a composite board or panel.

The inventors also found that one or more optional additives in the phenolic resin compositions, such as rheology modifiers, surfactants, or both, can provide beneficial properties. Rheology modifiers (such as polyhydric alcohols, for example, glycols and/or glycerol, among others) can partially replace water in the resin composition solution. A rheology modifier can be added to a polymer precursor mixture during reaction to form the alkylphenol-phenol-aldehyde polymer. Additionally, or alternatively, the rheology modifier can be added to the alkylphenol-phenol-aldehyde polymer and wax emulsion. The rheology modifier can help solvate the polymer solution to facilitate molecular weight advancement. Such replacement can, for example, increase the solids content of the resin composition which can improve heat transfer during lignocellulosic composite manufacturing, improve resin flow, and improve penetration of the resin when applied to the substrate. Surfactants can aid in resin distribution and penetration control on the lignocellulosic substrate.

In some embodiments, different amounts of catalyst, such as sodium hydroxide, were utilized for forming alkylphenol-phenol-aldehyde polymers of different molecular weight distributions.

In contrast to conventional resin compositions, the resin compositions described herein are fast curing, high molecular weight resin compositions. In addition, lignocellulosic composite materials fabricated with resin compositions described herein have improved mechanical properties relative to conventional technologies.

The use of headings is for purposes of convenience only and does not limit the scope of the present disclosure. Aspects described herein can be combined with other aspects. As used herein, a “composition” can include component(s) of the composition, reaction product(s) of two or more components of the composition, and/or a remainder balance of remaining starting component(s). Compositions of the present disclosure can be prepared by any suitable mixing process.

### Resin Compositions

Resin compositions of the present disclosure can include an alkylphenol-phenol-aldehyde polymer composition and a wax emulsion. The resin compositions can further include one or more additional additives. The one or more additional additives can include a rheology modifier, a surfactant, or combinations thereof. The rheology modifier can come from that rheology modifier used during the synthesis of the alkylphenol-phenol-aldehyde polymer composition. Additionally, or alternatively, rheology modifier can be added to the alkylphenol-phenol-aldehyde polymer composition and wax emulsion.

As further described below, resin compositions of the present disclosure can be used with a lignocellulosic substrate to form articles such as oriented strand board, particle board, fiberboard, medium density fiberboard, construction board, composite panels, and plywood, though other applications are contemplated.

### Alkylphenol-Phenol-Aldehyde Polymer Composition

An alkylphenol-phenol-aldehyde polymer composition can be formed by reacting a mixture comprising two or more phenolic compounds, an aldehyde, and a catalyst. The mixture can further include one or more optional components such as a solvent, a rheology modifier, or combinations thereof, among other optional components. The rheology modifier can be utilized to help solvate the polymer solution to facilitate molecular weight advancement.

The two or more phenolic compounds include an alkylphenol compound and a phenol compound. The phenol compound can include phenol, resorcinol, or combinations thereof. The alkylphenol compound can facilitate improved water properties, such as water absorption and thickness swell, of compositions described herein and articles produced using such compositions. Any suitable alkylphenol compound can be utilized. Suitable alkylphenols can be represented Formula (I):

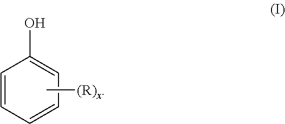

In Formula (I), R is an unsubstituted hydrocarbyl, a substituted hydrocarbyl, or a functional group comprising at least one element from Group 13-17 of the periodic table of the elements. In Formula (I), x represents the number of R groups connected to the aromatic ring, and can be an integer from 1 to 4, such as from 1 to 3, such as 1, 2, 3, or 4.

In Formula (I), at least one R group is an unsubstituted hydrocarbyl or a substituted hydrocarbyl. When more than one R group is present, the R groups can be the same or different.

The R group of Formula (I) has any suitable number of carbon atoms such as from 1 to 100 carbon atoms, such as from 1 to 50 carbon atoms, such as from 1 to 40 carbon atoms, such as from 2 to 30 carbon atoms, such as from 3 to 20 carbon atoms, such as from 6 to 15 carbon atoms. The number of carbon atoms in the R group of Formula (I) can be about 15, at least about 10, less than about 20, more than about 12, or from about 10 to about 20. The R group of Formula (I) can be unsubstituted or substituted, linear or branched, saturated or unsaturated, cyclic or acyclic. Regarding saturation, the R group of Formula (I) can be fully saturated, partially unsaturated, or fully unsaturated.

R of Formula (I) can be an unsubstituted hydrocarbyl. An “unsubstituted hydrocarbyl” refers to a group that consists of hydrogen and carbon atoms only. Illustrative, but non-limiting, examples of unsubstituted hydrocarbyl include an alkyl group having from 1 to 40 carbon atoms, such as from 1 to 20 carbon atoms such as methyl, ethyl, n-propyl, isopropyl, n-butyl, iso-butyl, sec-butyl, and tert-butyl, pentyl, hexyl, heptyl, octyl, ethyl-2-hexyl, isooctyl, nonyl, n-decyl, undecyl, dodecyl, tridecyl, tetradecyl, pentadecyl, hexadecyl, heptadecyl, octadecyl, nonadecyl, icosyl, or isomers thereof; a cycloaliphatic group having from 3 to 20 carbon atoms such as, for example, cyclopentyl or cyclohexyl; an aromatic group having from 6 to 20 carbon atoms such as, for example, phenyl or naphthyl; or any combination thereof.

R of Formula (I) can be a substituted hydrocarbyl. A “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

When at least one R group is an unsubstituted hydrocarbyl or a substituted hydrocarbyl, another R group (when x>1) can be a functional group comprising at least one element from Group 13-17 of the periodic table of the elements. When an R group is a functional group comprising at least one element from Group 13-17, the R group can be halogen (F, Cl, Br, or I), O, N, Se, Te, P, As, Sb, S, B, Si, Ge, Sn, Pb, and the like, such as C(O)R*, C(C) NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

As used herein, reference to an R group, alkyl, substituted alkyl, hydrocarbyl, or substituted hydrocarbyl without specifying a particular isomer (such as butyl) expressly discloses all isomers (such as n-butyl, iso-butyl, sec-butyl, and tert-butyl). For example, reference to an R group having 4 carbon atoms expressly discloses all isomers thereof. When a compound is described herein such that a particular isomer, enantiomer or diastereomer of the compound is not specified, for example, in a formula or in a chemical name, that description is intended to include each isomer and enantiomer of the compound described individual or in any combination.

More than one alkylphenol compound can be utilized. The alkylphenol of Formula (I) can include cardanol, cresol, xylenol, ethyl phenol, alkyl resorcinol, isomers thereof, or combinations thereof. Suitable isomers for the alkylphenol compound include ortho-, meta-, and para-isomers, such as ortho-, meta-, and para-cresol. For purposes of the present disclosure, alkyl resorcinols are dihydroxy benzenes having one or two alkyl chains present on the ring. The one or two alkyl chains present on the ring of alkyl resorcinols can have 1 to 3 carbon atoms, though higher numbers of carbon atoms are contemplated.

An illustrative, but non-limiting, example of an alkylphenol is cardanol. In at least one embodiment, the R group of Formula (I) is C₁₅H₃₀₋ₙ, wherein n is 0, 2, 4, or 6, and the cardanol has the Formula (II):

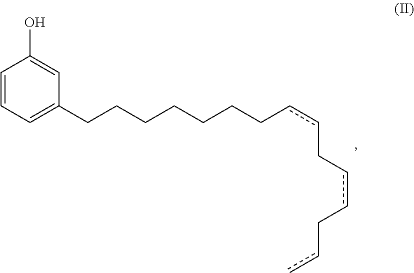

In Formula (II), the dashed lines indicate the presence or absence of unsaturation. As an example, tri-unsaturated cardanol (R=C₁₅H₂₄; CAS No. 37330-39-5) is shown below as the following structure:

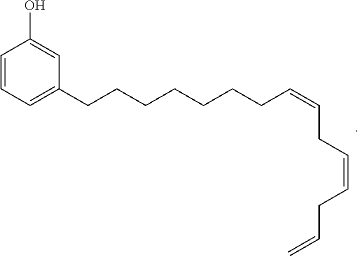 [SMILES: C=CC/C=C\C/C=C\CCCCCCCc1cccc(O)c1]

As another example, mono-unsaturated cardanol (R=C₁₅H₂₈; CAS No. 8007-24-7) is shown below as the following structure:

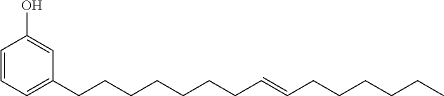 [SMILES: CCCCCC/C=C/CCCCCCCc1cccc(O)c1]

The double bond(s) in cardanol can be cis, trans, or combinations thereof.

One or more phenolic compounds can be utilized in the polymer compositions described herein. Moreover, one or more alkylphenols, such as one or more cardanols, can be utilized in compositions described herein. For example, a composition described herein can include a mixture of two or more of the following cardanols having Formula (II): tri-unsaturated cardanol (R=C₁₅H₂₄; as shown in the structure above), a bi-unsaturated cardanol (R=C₁₅H₂₆), a mono-unsaturated cardanol (R=C₁₅H₂₈), and saturated cardanol (R=C₁₅H₃₀), in any suitable proportions.

The alkylphenol utilized can be in the form of a distillate, such as a cashew nut distillate (CND), such as cashew nut distillate under the tradename 1500-1 from Palmer International Inc.

The aldehyde can be any suitable aldehyde such as formaldehyde. Besides formaldehyde, paraformaldehyde ((CH₂O)ₙ) can be used as a source of formaldehyde. Additionally, or alternatively, formalin (an aqueous solution of formaldehyde) can be utilized as a source of formaldehyde. Additionally, or alternatively, an alkyl aldehyde can be utilized. Suitable alkyl aldehydes include those alkyl aldehydes having from 1 to 20 carbon atoms, such as from 1 to 12 carbon atoms or 3 to 15 carbon atoms, such as from 5 to 12 carbon atoms, though other alkyl aldehydes are contemplated. The number of carbon atoms in the alkyl aldehyde can be 1, 2, 3, 4, 5, 6, 7, 8, 9, 10, 11, 12, 13, 14, 15, 16, 17, 18, 19, or 20 carbon atoms, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Illustrative, but non-limiting examples, of alkyl aldehydes include 3,5,5-trimethyl hexanal, nonanal, 2-ethylhexanal, or combinations thereof. The polymer compositions of the present disclosure can be in the form of formaldehyde-free polymer compositions. Alternatively, polymer compositions described herein are in the form of formaldehyde-containing polymer compositions.

Other aldehydes, as well as ketones, are also contemplated. The aldehyde can include formaldehyde, paraformaldehyde, an alkyl aldehyde, or combinations thereof.

When the aldehyde is formaldehyde, the alkylphenol-phenol-aldehyde polymer composition is an alkylphenol-phenol-formaldehyde polymer (APFP) composition.

An amount of the individual phenolic compounds, the amount of the aldehyde, a molar ratio thereof, or combinations thereof, can determine the molecular structure and physical properties of the polymer composition.

For purposes of the present disclosure, the weight percent (wt %) of each component in polymer compositions described herein is based on a percent solid weight basis (% solid weight basis). A total wt % of the polymer compositions described herein does not exceed 100 wt %.

A total amount (in wt %) of the phenolic compounds (alkylphenol compound and phenol compound) in the polymer composition can be from about 0.1 wt % to about 40 wt %, such as from about 0.5 wt % to about 40 wt %, such as from about 1 wt % to about 35 wt %, such as from about 10 wt % to about 30 wt %, such as from about 15 wt % to about 25 wt %, based on the total wt % of the polymer composition. Other amounts are contemplated. Any of the foregoing numbers can be used singly to describe an open-ended range or in combination to describe a close-ended range. A total amount (in wt %), of the at least phenolic compounds in the polymer composition, based on a total weight of the polymer composition, can be 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

A total wt % of the alkylphenol compound can be greater than 0 wt %, about 15 wt % or less, or combinations thereof, such as from greater than 0 wt % to about 12 wt %, such as from about 0.1 wt % to about 12 wt %, such as from about 0.9 wt % to about 10 wt %, such as from about 1 wt % to about 10 wt %, such as from about 2 wt % to about 8 wt %, such as from about 4 wt % to about 6 wt %, based on a total wt % of two or more phenolic compounds, the total wt % of two or more phenolic compounds not to exceed 100 wt %. Other amounts are contemplated. Any of the foregoing numbers can be used singly to describe an open-ended range or in combination to describe a close-ended range.

A total wt % of the phenol compound can be about 85 wt % or more, less than 100 wt %, or combinations thereof, such as from about 85 wt % to less than 100 wt %, such as from about 88 wt % to less than 100 wt %, such as from about 88 wt % to about 99.9 wt %, such as from about 90 wt % to about 99.1, such as from about 90 wt % to about 99 wt %, such as from about 92 wt % to about 98 wt %, such as from about 94 wt % to about 96 wt %, though other amounts are contemplated. Any of the foregoing numbers can be used singly to describe an open-ended range or in combination to describe a close-ended range.

A total amount of aldehyde in the polymer composition can be from about 0.1 wt % to about 35 wt %, such as from about 0.5 wt % to about 35 wt %, such as from about 1 wt % to about 25 wt %, such as from about 2 wt % to about 10 wt %, such as from about 3 wt % to about 5 wt %, based on the total wt % of the polymer composition, though other amounts are contemplated. Any of the foregoing numbers can be used singly to describe an open-ended range or in combination to describe a close-ended range. A total amount (in wt %) of the aldehyde in the polymer composition, based on the total wt % of the polymer composition, can be 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of aldehyde to total amount of phenolic compounds (Aldehyde/(phenol compound+alkylphenol compound) can be from about 2 to about 2.7, such as from about 2.1 to about 2.6, such as from about 2.2 to about 2.5, such as from about 2.3 to about 2.4, though other amounts are contemplated. Any of the foregoing numbers can be used singly to describe an open-ended range or in combination to describe a close-ended range.

Suitable polymer compositions described herein may include a catalyst such as a base or an acid such that the polymer compositions may be in the form of resole resins or novolac resins. Resole resins are formed when prepared using a base and novolac resins are formed when prepared using an acid. The base or acid acts as a catalyst, for the reaction between the at least one phenolic compound and the at least one aldehyde. Illustrative, but non-limiting, examples of suitable bases include potassium hydroxide (KOH), sodium hydroxide (NaOH), lithium hydroxide (LiOH), barium hydroxide (Ba(OH)₂), calcium hydroxide (Ca(OH)₂), ammonium hydroxide (NH₄OH), organic amines, sodium carbonate, potassium carbonate, or combinations thereof. Illustrative, but non-limiting, examples of suitable acids include inorganic acids and organic acids, such as hydrochloric acid (HCl), sulfuric acid (H₂SO₄), nitric acid (HNO₃), phosphoric acid (H₃PO₄), sulfonic acid, sulfamido acids, haloacetic acids, or combinations thereof. Other bases and acids are contemplated.

A total amount of catalyst, such as a base, in the polymer composition can be from about 0.1 wt % to about 15 wt %, such as from about 0.5 wt % to about 10 wt %, such as from about 1 wt % to about 9 wt %, such as from about 2.5 wt % to about 8 wt %, such as from about 3 wt % to about 5 wt %, based on the total wt % of the polymer composition. The total amount (in wt %) of the at least one base (or acid, if used) in the polymer composition, based on the total wt % of the polymer composition, can be 0.1, 0.5, 1, 2, 3, 4, 5, 6, 7, 8, 9, 10, 11, 12, 13, 14, or 15, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Besides the phenolic compounds, the aldehyde, and the catalyst (base or acid), the polymer compositions described herein can further at least one rheology modifier such as a polyhydric alcohol. The polyhydric alcohol can include two or more hydroxyl groups, such as diols and triols. Illustrative, but non-limiting, examples of suitable polyhydric alcohols can include glycerol, crude glycerin, refined glycerin, ethylene glycol, diethylene glycol, propylene glycol, propane-1,2,3-triol, propanetriol, 1,2,3-trihydroxypropane, 1,2,3-propanetriol, or combinations thereof. Other suitable polyols include polyether polyols. Crude glycerin includes compositions that are not purified and are commonly used and commercially available in the industry. Other components in crude glycerin include methanol, water, and various organic compounds based on the precursor material, among others. However, specifications for crude glycerin other than the glycerol content vary widely.

Crude glycerins are separated from both the 97+% Technical Grade and the 99+% Refined Grade. Refined Glycerin can also be further classified as Kosher, USP (United States Pharmacopeia), or USP Kosher depending upon source and handling. One example of crude glycerin is 82% to 85% glycerin, which crude glycerin is most common as most bio-diesel plants do not upgrade beyond 82% to 85%. Another example of crude glycerin is 92% to 95% glycerin. The 92% to 95% crude glycerin is much less common as relatively few biodiesel plants either produce or upgrade to the 92% to 95% crude glycerol levels. Polymer compositions described herein can include crude glycerin, such as 82% to 85% glycerin or 92% to 95% glycerin, alone or in combination.

In some examples, a crude glycerin of 82% to 85% glycerin can include a mixture of glycerin as glycerol CAS No. 56-81-5, sodium chloride CAS #7647-14-15, sodium sulfate 7757-82-6, water CAS No. 7732-18-5, and MONG (Matter Organic, Non Glycerol). In at least one example, a crude glycerin of 92% to 95% glycerin can include a mixture of glycerin, 1,2,3-propanetriol and fatty acid methyl esters, such as glycerin as glycerol CAS No. 56-81-5, water CAS No. 7732-18-5, potassium sulfate CAS No. 7778-80-5, fatty acid esters CAS No. 68937-84-8, and methanol CAS No. 7732-18-5. Other crude glycerins are contemplated.

A total amount of the polyhydric alcohol in the polymer composition can be less than about 25 wt %, such as from about 0.1 wt % to about 25 wt %, such as from about 0.5 wt % to about 20 wt %, such as from about 1 wt % to about 15 wt %, such as from about 1 wt % to about 12 wt %, such as from about 2 wt % to about 10 wt %, such as from about 4 wt % to about 6 wt %, based on the total wt % of the polymer composition. A total amount, in wt %, of the rheology modifier (such as the polyhydric alcohol), based on the total wt % of the polymer composition, can be 0, 0.1, 0.5, 1, 2, 3, 4, 5, 6, 7, 8, 9, 10, 11, 12, 13, 14, 15, 16, 17, 18, 19, 20, 21, 22, 23, 24, or 25, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The polymer compositions can optionally include urea. The total amount of urea in the polymer composition can be about 30 wt % or less, such as from about 0.1 wt % to about 30 wt %, such as from about 0.1 wt % to about 25 wt %, such as from about 1 wt % to about 20, such as from about 5 wt % to about 15 wt %, such as from about 5 wt % to about 10 wt % or from about 10 wt % to about 15 wt %, based on the total wt % of the polymer composition. The amount of urea (in wt %) in the polymer composition, based on the total weight of the polymer composition, can be 0, 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The polymer composition can further include a solvent such as water, an organic solvent, or both. Non-limiting examples of organic solvents include n-butanol, toluene, xylene, or mixtures thereof. A total amount of solvent (water, organic solvent, or both) in the polymer composition, is from about 1 wt % to about 99 wt %, such as from about 10 wt % to about 90 wt %, such as from about 30 wt % to about 70 wt %, such as from about 40 wt % to about 60 wt %, such as from about 45 wt % to about 58 wt %, based on the total wt % of the polymer composition, though other amounts are contemplated. Any of the foregoing numbers can be used singly to describe an open-ended range or in combination to describe a close-ended range.

When the polymer composition includes the solvent, such as water, one or more components of the polymer composition may exist as one or more ions. For example, one or more anions, such as Cl, or one or more cations, such as Na, may exist in the composition.

Additional components of the polymer compositions described herein may include surfactants, defoamers, or combinations thereof.

The degree of polymerization to form an alkylphenol-phenol-aldehyde pre-polymers and polymers can be carried out such that various condensation products are formed such as methylolated phenols, oligomers, polymers of intermediate size, large polymers, and very large polymers. Number average molecular weight (Mn), weight average molecular weight (Mw) and z-average molecular weight (Mz) are determined by gel permeation chromatography (GPC) relative to the sets of varying molecular weight internal standard (polystyrene sulfonate sodium salt) used to generate calibration curve to fit the molecular weights of the alkylphenol-phenol-aldehyde polymer. The molecular weight moments (distribution average) are calculated using ultra violet detector. The distribution weight values are categorized as Mn, Mw, and Mz. The Mn is the number of molecules per unit mass (average chain length) which is sensitive to low molecular weight species. Mw is the weighted average molecular mass in the sample and Mz is the average molecular weight mainly sensitive to larger molecules.

The alkyl-phenol-formaldehyde polymer can have a Mn value in a range from about 200 g/mol to about 800 g/mol, a Mw value in a range from about 20,000 g/mol to about 40,000 g/mol, a Mz value in a range from about 200,000 g/mol to about 300,000 g/mol, or combinations thereof.

An alkylphenol-phenol-aldehyde condensation product can be formed from a polymer composition described herein is formed from a polymer composition described herein. The polymer composition percentage is calculated from the elution retention time and Detector Response (mV) chromatogram obtained from ultraviolet detector for each species (small molecular weight, oligomers, intermediate and large/very large polymer).

The polymer composition can have one or more of the following properties or characteristics:

(a) A first component that includes methylolated phenols and phenol, a second component that includes oligomers, a third component that includes polymers of intermediate size, a fourth component that includes large polymers and very large polymers, or combinations thereof. A total % of the species present in the polymer composition is based on the % of the very large polymers, the large polymers, polymers of intermediate size, oligomers, methylolated phenols, and phenol, and does not exceed 100%.

(b) A percent of first component that includes methylolated phenols and phenol, based on the total % of the species present in the polymer composition, that is from about 0% to about 10%, such as from about 2% to about 8%, such as from about 4% to about 6%, though other values are contemplated. Any of the foregoing numbers can be used singly to describe an open-ended range or in combination to describe a close-ended range.

(c) A percent of second component that includes oligomers, based on the total % of the species present in the polymer composition, that is from about 4% to about 20%, such as from about 8% to about 16%, such as from about 10% to about 14%, though other values are contemplated. Any of the foregoing numbers can be used singly to describe an open-ended range or in combination to describe a close-ended range.

(d) A percent of third component that includes polymers of intermediate size, based on the total % of the species present in the polymer composition, that is from about 5% to about 20%, such as from about 8% to about 16%, such as from about 10% to about 15%, though other values are contemplated. Any of the foregoing numbers can be used singly to describe an open-ended range or in combination to describe a close-ended range.

(e) A percent of fourth component that includes large polymers and very large polymers, based on the total % of the species present in the polymer composition, that is from about 50% to about 90%, such as from about 55% to about 85%, such as from about 60% to about 80%, such as from about 65% to about 75%, though other values are contemplated. Any of the foregoing numbers can be used singly to describe an open-ended range or in combination to describe a close-ended range.

The composition of species (first component, second component, third component, and fourth component) is calculated based on UV detector response (mV) and elution time in minutes. The large and very large polymers are eluted at about 20 minutes to about 27.5 minutes, the polymers of intermediate size are eluted at about 27.5 minutes to about 31.9 minutes, the oligomers are eluted at about 31.9 minutes to about 36.5, the methylolated phenols are eluted at about 36.8 minutes to about 42 minutes, and the phenol is eluted at about 44.8 minutes. The percent composition of these species is calculated from the ratio of the UV response trace (mV) for each categories of species in the range of the of elution time mentioned above to the total UV response trace (mV) for all species eluted from about 20 minutes to about 44.8 minutes.

(f) A total solids content (in units of % non-volatile solids) in polymer compositions can be any suitable amount such as from about 40 wt % to about 60 wt %, such as from about 42 wt % to about 55 wt %, such as from about 44 wt % to about 52 wt %, such as from about 46 wt % to about 50 wt %, based on the total % of the polymer composition, other amounts are contemplated. Any of the foregoing numbers can be used singly to describe an open-ended range or in combination to describe a close-ended range.

(g) An alkalinity (in pH values) of the polymer composition that can be about 7.5 or more, such as from about 8.5 to about 13, or at least about 8, or less than about 14. The alkalinity (in pH values) can be 7.5, 8, 8.5, 9, 9.5, 10, 10.5, 11, 11.5, 12, 12.5, 13, 13.5, or 14, or ranges thereof. Each of the foregoing numbers can be preceded by the word “about,” “at least about,” “less than about,” or “more than about,” and any of the foregoing numbers can be used singly to describe an open-ended range or in combination to describe a close-ended range.

The alkylphenol-phenol-aldehyde polymer composition can be characterized as including a high molecular weight component and a low molecular weight component. The high molecular weight component can include large polymers, very large polymers, or combinations thereof. The low molecular weight component can include phenol, methylolated phenols, oligomers, polymers of intermediate size, or combinations thereof.

The alkylphenol-phenol-aldehyde polymer composition can include the high molecular weight component in an amount that is from about 50 wt % to about 90 wt %, such as from about 55 wt % to about 85 wt %, such as from about 60 wt % to about 80 wt %, such as from about 65 wt % to about 75 wt %, based on a total wt % of the alkylphenol-phenol-aldehyde polymer, the total wt % of the alkylphenol-phenol-aldehyde polymer not to exceed 100 wt %. Any of the foregoing numbers can be used singly to describe an open-ended range or in combination to describe a close-ended range.

The alkylphenol-phenol-aldehyde polymer can include the low molecular weight component in an amount that is from about 10 wt % to about 50 wt %, such as from about 15 wt % to about 45 wt %, such as from about 20 wt % to about 40 wt %, such as from about 25 wt % to about 35 wt %, based on a total wt % of the alkylphenol-phenol-aldehyde polymer. Any of the foregoing numbers can be used singly to describe an open-ended range or in combination to describe a close-ended range.

One or more alkylphenol-phenol-aldehyde compositions can be utilized with embodiments described herein. For example, a first alkylphenol-phenol-aldehyde composition and a second alkylphenol-phenol-aldehyde composition can be combined in any suitable amounts. The first alkylphenol-phenol-aldehyde composition can be characterized as including a higher amount of low molecular weight components than the second alkylphenol-phenol-aldehyde composition, and the second alkylphenol-phenol-aldehyde composition can be characterized as including a higher amount of high molecular weight components.

Here, resin compositions described herein can include a ratio of high molecular weight alkylphenol-phenol-aldehyde to low molecular weight alkylphenol-phenol-aldehyde that is from about 7:3 to about 9:1, such as from about 7.5:2.5 to about 8.5:1.5, such as about 8:2. Any of the foregoing numbers can be used singly to describe an open-ended range or in combination to describe a close-ended range. As further described below, resin compositions described herein further include a wax emulsion.

Table 1 provides a non-limiting example of percent structural identity of an alkylphenol-phenol-aldehyde polymer composition obtained from Carbon-13 nuclear magnetic resonance (13C NMR) analysis. Table 2 provides structural identity description with typical chemical shifts.

TABLE 1
Percent structural identity

| | % |
|---|---|
| Cardanol alkyl chain (R group) | 0-5 |
| Methylene bridge o-o, methylene bridge p-o, | 1-10 |
| and cardanol alkyl chain | |
| Methylene bridge p-o and methylene bridge p-p | 1-5 |
| Methylol ortho | 1-5 |
| Methylol para | 10-20 |
| Unsubstituted aromatic meta, substituted | 40-50 |
| aromatic ortho, and cardanol alkyl chain | |
| Phenoxy | 20-30 |

TABLE 2
Structural identity description
Methylene bridges and methylols

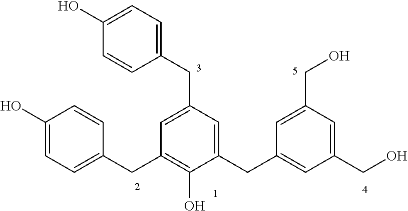 [SMILES: OCc1cc(CO)cc(Cc2cc(Cc3ccc(O)cc3)cc(Cc3ccc(O)cc3)c2O)c1]

Dimethylene ethers, aromatic, and
phenoxy Carbons

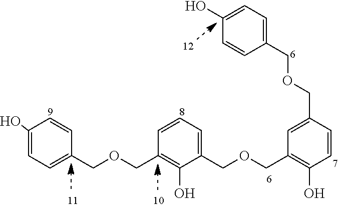 [SMILES: Oc1ccc(COCc2ccc(O)c(COCc3cccc(COCc4ccc(O)cc4)c3O)c2)cc1]

| Carbon number | Carbon type | Chemical shift, ppm |
|---|---|---|
| 1 | methylene bridges, ortho-ortho | 29-31 |
| 2 | methylene bridges, para-ortho | 34-36 |
| 3 | methylene bridges, para-para | 39-42 |
| 4 | methylol, ortho | 60-63 |
| 5 | methylol, para | 63-67 |
| 6 | dimethylene ether bridges | 65-75 |
| 7 | unsubstituted aromatic, ortho | 111-118 |
| 8 | unsubstituted aromatic, para | 118-122 |
| 9 | unsubstituted aromatic, meta | 123-132 |
| 10 | substituted aromatic, ortho | 123-132 |
| 11 | substituted aromatic, para | 132-137 |
| 12 | phenoxy carbons | 148-159 |

The alkylphenol-phenol-aldehyde polymer composition can be made by any suitable process. For example, the alkylphenol-phenol-aldehyde polymer composition can be formed by a condensation reaction of a reaction mixture of the two or more phenolic compounds and the aldehyde. The reaction mixture can include those amounts described herein for polymer compositions.

The two or more phenolic compounds and the aldehyde are reacted in the presence of at least one base or at least one acid, such as one or more of the bases and acids described above, to form a reaction mixture that includes an alkylphenol-phenol-aldehyde polymer product. A resole resin may be formed when a base catalyst is used and a novolac resin may be formed when an acid catalyst is used. During the condensation reaction, water is also produced. At least a portion of the water produced can be removed by distillation, azeotropic distillation, vacuum distillation, among other suitable methods during, after, or both during and after formation of the alkylphenol-phenol-aldehyde polymer composition.

For forming the alkylphenol-phenol-aldehyde polymer compositions, the weight percentages of the phenolic compounds and the aldehyde, described above, may be utilized. Alternatively, the alkylphenol-phenol-aldehyde polymer composition can be formed using a molar ratio of the aldehyde to the total amount of phenolic compounds that is from about 1:1 to about 4.5:1, such as from about 1.5:1 to about 3.5:1, such as from about 1.5:1 to about 2.8:1, such as from about 2:1 to about 2.5, though higher or lower molar ratios are contemplated.

Water may be utilized as a solvent for the condensation reaction. An organic solvent may be used in the condensation reaction, and the organic solvent may form an azeotrope with water. For example, n-butanol, toluene, xylene, and mixtures thereof can be employed. The solvent and reactant mixture can be heated to remove water at a temperature from about 90° C. to about 200° C., such as from about 100° C. to about 160° C., though higher or lower temperatures are contemplated. The solvents may also be removed during or after the condensation reaction. Additionally or alternatively, solvents (such as those which do not release protons under the condensation conditions) may remain in the products after the condensation reaction.

After the alkylphenol-phenol-aldehyde polymer composition is formed, the acid or base catalyst may be neutralized. The polymer composition can be used directly or after the neutralization of the acid or base catalyst.

The alkylphenol-phenol-aldehyde polymer of the alkylphenol-phenol-aldehyde polymer composition includes alkylphenol monomer units (corresponding to first monomers after polymerization), phenol compound monomer units (corresponding to second monomers after polymerization), and aldehyde compound comonomer units. In these and other embodiments, the alkylphenol-phenol-aldehyde polymer can have one or more of the following characteristics:

(a) An amount of alkylphenol monomer units in the alkylphenol-phenol-aldehyde polymer can be from greater than 0 wt % to about 15 wt %, such as from greater than 0 wt % to about 12 wt %, such as from about 0.1 wt % to about 12 wt %, such as from about 0.9 wt % to about 10 wt %, such as from about 1 wt % to about 10 wt %, such as from about 2 wt % to about 8 wt %, such as from about 4 wt % to about 6 wt %, based on a total wt % of the alkylphenol monomer units and phenol compound monomer units, the total wt % of alkylphenol monomer units and phenol compound monomer units not to exceed 100 wt %. Other amounts are contemplated. Any of the foregoing numbers can be used singly to describe an open-ended range or in combination to describe a close-ended range.

(b) An amount of phenol compound monomer units in the alkylphenol-phenol-aldehyde polymer can be from about 85 wt % to less than 100 wt %, such as from about 88 wt % to less than 100 wt %, such as from about 88 wt % to about 99.9 wt %, such as from about 90 wt % to about 99.1, such as from about 90 wt % to about 99 wt %, such as from about 92 wt % to about 98 wt %, such as from about 94 wt % to about 96 wt %, based on a total wt % of the alkylphenol monomer units and phenol compound monomer units, though other amounts are contemplated. Any of the foregoing numbers can be used singly to describe an open-ended range or in combination to describe a close-ended range.

Resin compositions described herein may optionally include a phenolic resin in addition to the alkylphenol-phenol-aldehyde polymer and wax emulsion. Any suitable phenolic resin can be utilized such as a commercially available phenolic resin. Phenolic resins can include a phenol-aldehyde polymer. Accordingly, and in some embodiments, a resin composition is provided that includes a wax emulsion described herein, an alkylphenol-phenol-aldehyde polymer described herein, and a phenolic resin.

### Wax Emulsion

In addition to the alkylphenol-phenol-aldehyde polymer composition, the resin composition further includes a wax emulsion. The term “wax emulsion”, as used herein, refers to an aqueous emulsion of one or more waxes which is emulsified. The wax emulsion can include a wax such as a petroleum-based wax, a coal-derived wax, a synthetic wax, a bio-based wax, or combinations thereof. The wax is emulsified to form the wax emulsion utilizing various chemistries including saponification, a non-ionic emulsifier, a lignosulfonate dispersant, or combinations thereof.

Petroleum based waxes can include paraffin waxes, oils, or combinations thereof, such as slack wax. The petroleum-based wax can have an average carbon chain length of about 29 to 39 carbon atoms. The petroleum-based wax can have a melting point that is from about 38° C. to about 70° C. The petroleum-based wax can have a minimum flashpoint of 218° C. or greater, such as from about 218° C. to about 271° C. An oil content of the petroleum-based wax can be less than about 20% by weight, such as from about 10% to less than 20 wt %, for example. The petroleum-based wax can have an average chain length of about 29 to 39 carbon atoms. Examples of petroleum-based waxes can include slack wax, scale wax, fully refined wax, or combinations thereof.

Coal-derived waxes refer to those waxes derived from lignite or brown coal. Coal-derived waxes. The coal-derived wax can have an acid value that is from about 5 mg KOH/g to about 35 mg KOH/g, a saponification value that is from about 80 mg KOH/g to about 105 mg KOH/g, a melting point that is greater than about 82.2° C., or combinations thereof. Montan wax is an illustrative, but non-limiting, example of a coal-derived wax.

Bio-based waxes refer to the category of plant and/or animal derived waxes processed from, for example, nonhydrogenated, partially hydrogenated, and/or fully hydrogenated fats and oils. Examples of these types of waxes can include palm wax, soy wax, carnauba wax, candelilla wax, tallow wax, bees wax, wool wax (lanolin), or combinations thereof.

Synthetic waxes refer to the polyethylene (PE) wax, Fischer Tropsch (FT) wax, or an alpha olefin (AO) wax derived from polymerization of ethylene.

As described above, the wax is emulsified to form the wax emulsion. The wax emulsion can be a composition. The wax emulsion can be emulsified using saponification. Saponification can be accomplished by combining the wax with a strongly basic material such as an alkali metal hydroxide or other hydroxide. Examples of such hydroxides include sodium hydroxide, potassium hydroxide, ammonium hydroxide, or combinations thereof. The amount of strongly basic material used to saponify a wax may be calculated based on the saponification value of the wax. For example, the saponification value divided by 1000 equals the grams of potassium hydroxide to add per gram of wax.

The wax emulsion can be prepared using a surfactant as a non-ionic emulsifier. Surfactants (or non-ionic emulsifiers) can include sorbitan monostearate, sorbitan isostearate, sorbitan laurate, sorbitan oleate, sorbitan palmitate, sorbitan sesquioleate, sorbitan monoisostearate ethoxylate, sorbitan monolaurate ethoxylate, sorbitan monooleate ethoxylate, sorbitan monopalmitate ethoxylate, sorbitan monostearate ethoxylate, sorbitan tetraoleate ethoxylate, sorbitan tetrastearate, ethoxylate, Sorbitan tristearate ethoxylate, sorbitan hexastearate ethoxylate, or combinations thereof. The non-ionic emulsifier can be used in an amount of about 1.0 wt % to about 15.0 wt % based on a total wt % of the wax emulsion, the total wt % of the wax emulsion not to exceed 100 wt %.

Additionally, or alternatively, the wax emulsion can be prepared using an ionic dispersant. The ionic dispersant can include a polynaphthalenesulfonic acid, a lignosulfonate, a lignosulfonate sodium salt, a polynaphthalene sulfonate calcium salt, or combinations thereof. The ionic dispersant can be used in an amount that is from about 0.1 wt % to about 20.0 wt % based on the total wt % of the emulsion.

In at least one embodiment, the wax emulsion comprises a lignosulfonate slack wax such as a sodium lignosulfonate slack wax.

Wax emulsions can be prepared by as follows. Water and water-soluble components are combined then heated to a temperature of between about 185° F. (85° C.) to about 205° F. (96.1° C.). The wax compounds are incorporated and heated to a temperature of between about 185° F. (85° C.) to about 205 F. (96.1° C.). The aqueous and wax mixtures are combined. The resultant mixture is then placed in a homogenizer to achieve a range of distribution of micelle diameters. The distribution of micelle diameters can range from about 0.3 micron to about 1.5 micron, such as from about 0.4 micron to about 1 micron. This level of homogenization can be attained, for example, by using a dual orifice homogenizer operating at from about 3,000 psig to about 8,000 psig.

Wax emulsions useful herein can have various properties. The emulsions of the can be stable for at least 1 week, such as for at least one 1 month, and for example, for at least 6 months. The wax emulsion formed can have a pH of less than 12.5, such as from about 8.0 to about 12.4. The wax emulsions can have a viscosity that is from about 10 cps to about 50 cps, such as from about 5 cps to about 20 cps. A mean solids content of the wax emulsions can be from about 40% to about 60% by weight.

The alkylphenol-phenol-aldehyde polymer composition and the wax emulsion can be mixed by any suitable technique to form a resin composition. For example, a wax emulsion can be introduced with an alkylphenol-phenol-aldehyde polymer composition under normal agitation conditions to form the resin composition as a blend or mixture.

The resin composition includes an alkylphenol-phenol-aldehyde polymer composition, a wax emulsion, and one or more optional components. For purposes of the present disclosure, the wt % of each component in resin compositions described herein is based on a percent solid weight basis (% solid weight basis). A total wt % of a resin composition described herein does not exceed 100 wt %.

A resin composition can include an amount of alkylphenol-phenol-aldehyde polymer composition that can be from about 70 wt % to less than 100 wt %, such as from about 70 wt % to about 99 wt %, from about 75 wt % to about 95 wt %, from about 80 wt % to about 90 wt %, from about 85 wt % to about 99 wt %, from about 85 wt % to about 95 wt %, or from about 85 wt % to about 90 wt %, though other amounts are contemplated. Any of the foregoing numbers can be used singly to describe an open-ended range or in combination to describe a close-ended range.

A resin composition can include a resin composition includes an amount of wax emulsion that can be from greater than 0 wt % to about 30 wt %, such as from about 1 wt % to about 30 wt %, from about 5 wt % to about 15 wt %, from greater than 0 wt % to about 13 wt %, from about 2 wt % to about 12 wt %, from about 4 wt % to about 10 wt %, or from about 6 wt % to about 8 wt %, though other amounts are contemplated. Any of the foregoing numbers can be used singly to describe an open-ended range or in combination to describe a close-ended range

Resin compositions described herein can be single component systems (1K systems) as polymerization does not occur prior to application of a stimulus, for example, heat. 1K systems already comprise all of the necessary ingredients and are stable in storage. It is also contemplated that resin compositions described herein are suitable as a storable component for a 2K system or other multi-component system.

Resin compositions described herein can be a curable resin composition. The curable resin composition can be a 1K system.

The stoichiometry ranges described above for the components utilized to form the alkylphenol-phenol-aldehyde polymer can enable formation of various types of polymer distribution and polydispersity to generate desired molecular weight species, linkages and functionality. The hydrocarbon chain of the alkylphenol can enhance the water properties due to the alkylphenol's hydrophobicity. The hydrocarbon chain of the alkylphenol chain may also prevent the phenol formaldehyde polymer from wash out during the steam application. It was also observed the presence of the alkylphenol can reduce the surface tension which allows good resin distribution and surface area coverage of the polymer to the substrate.

In addition to the use of alkylphenols, the wax emulsion can further enhance the water properties of the resin compositions. Water in the resin solution slows down cure speed due to higher energy and longer cycle time required to evaporate the moisture in a very short press cycle time during application. To overcome the cure process and improve heat transfer, and in some embodiments, some of the water can be replaced with a rheology modifier such as a polyhydric alcohol, for example, glycerol, diethylene glycol, or ethylene glycol. These rheology modifiers can serve to solvate polymer solution as water during the synthesis and still achieve desired molecular weight distribution. The rheology modifier can also improve polymer flow and penetration into a substrate (e.g., a lignocellulosic substrate) for better bonding.

### Uses and Articles

Embodiments of the present disclosure also relate to uses of the resin compositions described herein. The resin compositions described herein can be used as binders, adhesives, sealants, or coatings, among other uses, for a variety of applications such as cellulosic, lignocellulosic, and wood products, including structural cellulosic, lignocellulosic, and wood products, materials, or composites. Such products, materials, and composites include, but are not limited to, oriented strand board (OSB), particle board, fiberboard, medium density fiberboard, construction board, composite panels, and plywood, though other applications are contemplated. The resin compositions can be used in building construction or any suitable fabrication where cellulosic, lignocellulosic, or wood products are used. The resin compositions can be used generally for producing composites, adhesives, insulation materials, shaped products, binders, laminates, among other articles and articles of manufacture. Accordingly, and in some embodiments, an article includes a resin composition described herein; and a cellulosic or wood product, material or composite.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Various alkylphenol-phenol-aldehyde polymers were made and blended with a wax emulsion to form embodiments of resin compositions described herein. OSB mats formed and cured with example resin compositions and a commercial resin were evaluated. The inventors found that the cashew nut distillate can provide water resistance, moisture resistance, reduced surface tension, valuable wetting properties, and flexibility to finished OSB mats.

### Evaluation of OSB Samples

Internal bonding was evaluated by the following procedure. After the OSB panel was made, a 2 inch×2 inch sample specimen was cut from the OSB panel and glued to stainless steel blocks on both sides then pulled apart using a tensile instrument to measure tensile bonding strength. Internal bonding was measured in pounds per square inch, psi.

Water absorption and thickness swelling were determined by the following procedure. A 6 inch×6 inch sample was cut from the OSB panel. The initial weight of the sample was measured. The initial thickness of all 4 sides of the panel 1 inch in from the edge was also measured using a micrometer. The sample was placed in a temperature-controlled bath of 21° C. for 24 hours such that the surface of the panel is submerged 1 inch below the surface. After 24 hours, the sample is removed and drained. The final weight was measured. The final thickness of all 4 sides of the panel 1 inch in from the edge was also measured using a micrometer. The percent water absorption (% WA) and percent thickness swell (% TS) were calculated by the following equations:

% WA=((final weight−initial weight)/(initial weight))×100%

TS=((final thickness−initial thickness)/(initial thickness))×100

Durability (maximum momentum breaking load) was determined by the following procedure. A 4.5 inch×14 inch sample was cut from the OSB panel. The sample was soaked in a bath at a temperature of 65° C. and a pressure of −15 mmHg for 30 minutes then at atmospheric pressure for 30 minutes. Samples were dried at 82° C. until all moisture is evaporated out. Maximum momentum breaking load was measured. This test simulates extreme humidity and moisture exposure to OSB. Durability (maximum momentum breaking load) was measured in units of pound-force inch (lbf·in).

### Example 1: Example Alkylphenol-Phenol-Aldehyde Polymer

Scheme 1 shows an example addition reaction. Generally, the reaction includes forming a mixture comprising phenol (A), cashew nut distillate (B), formaldehyde (C), and a sodium hydroxide (NaOH), and heating the resulting mixture. Urea and/or polyhydric alcohol can also be in the mixture. The cashew nut distillate (B) is mono-unsaturated cardanol (CAS No. 8007-24-7, 3-Pentadec-8-enylphenol) available from Palmer International (1500-1) shown in Scheme 1.

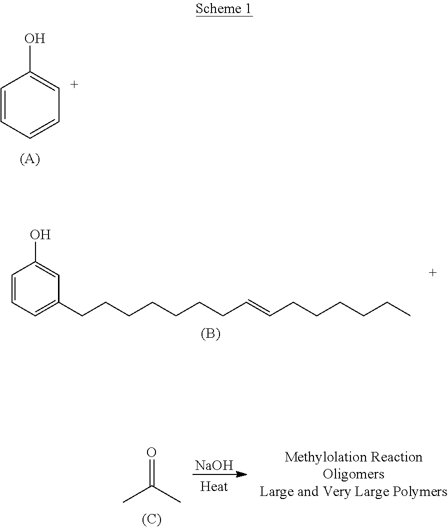

Tri-unsaturated cardanol (CAS No. 37330-39-5), shown below, can also be utilized: shown in Scheme 1.

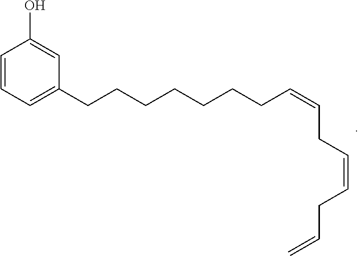 [SMILES: C=CC/C=C\C/C=C\CCCCCCCc1cccc(O)c1]

Various reactions occur upon heating the mixture, such as methylolation reactions (Scheme 2), pre-condensation reactions to form oligomers (Scheme 3), and condensation reactions to form large and very large polymer linkages (Scheme 4). Reference to the term “polymers” includes reference to “oligomers” unless specified to the contrary or the context clearly indicates otherwise.

Scheme 2 shows selected methylolation reactions to form example methylolation reaction products. Reaction of phenol (A), cashew nut distillate (B), and formaldehyde (C) forms methylolated adducts (mono-hydroxymethyl sodium phenolate & mono-hydroxymethyl sodium alkylphenolate) (D) and (E). These methylolated products react with formaldehyde to form adducts (F) and (G) (di-hydroxymethyl sodium phenolate and di-hydroxymethyl sodium alkylphenolate which also react with formaldehyde to form adducts (H) and (I) (tri-hydroxymethyl sodium phenolate & tri-hydroxymethyl sodium alkyl phenolate). These adducts (D)-(I) include methylolated phenols which can make up at least a portion of compositions described herein. Although Scheme 2 shows the R group as the tri-unsaturated R group or mono-unsaturated R group, bi-unsaturated R groups are contemplated as described herein.

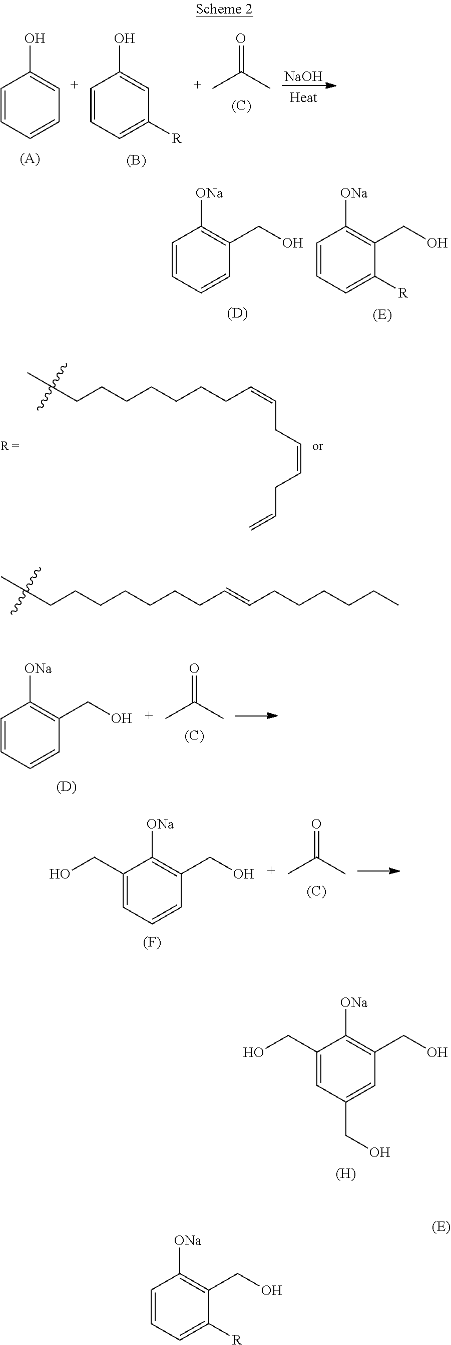

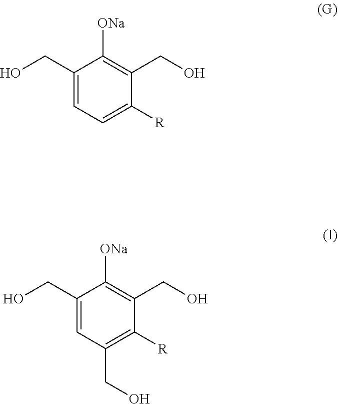

Scheme 3 shows illustrative, but non-limiting, examples of oligomers represented by Formulas (1-A)-(1-F) formed from pre-condensation reactions on a mixture comprising, for example, one or more of adducts (D)-(I). These oligomers (dimers, trimers & tetramers) represented by Formulas (1-A)-(1-F), among other oligomers, can make up at least a portion of compositions described herein. In Scheme 3, R is the group shown in Scheme 2.

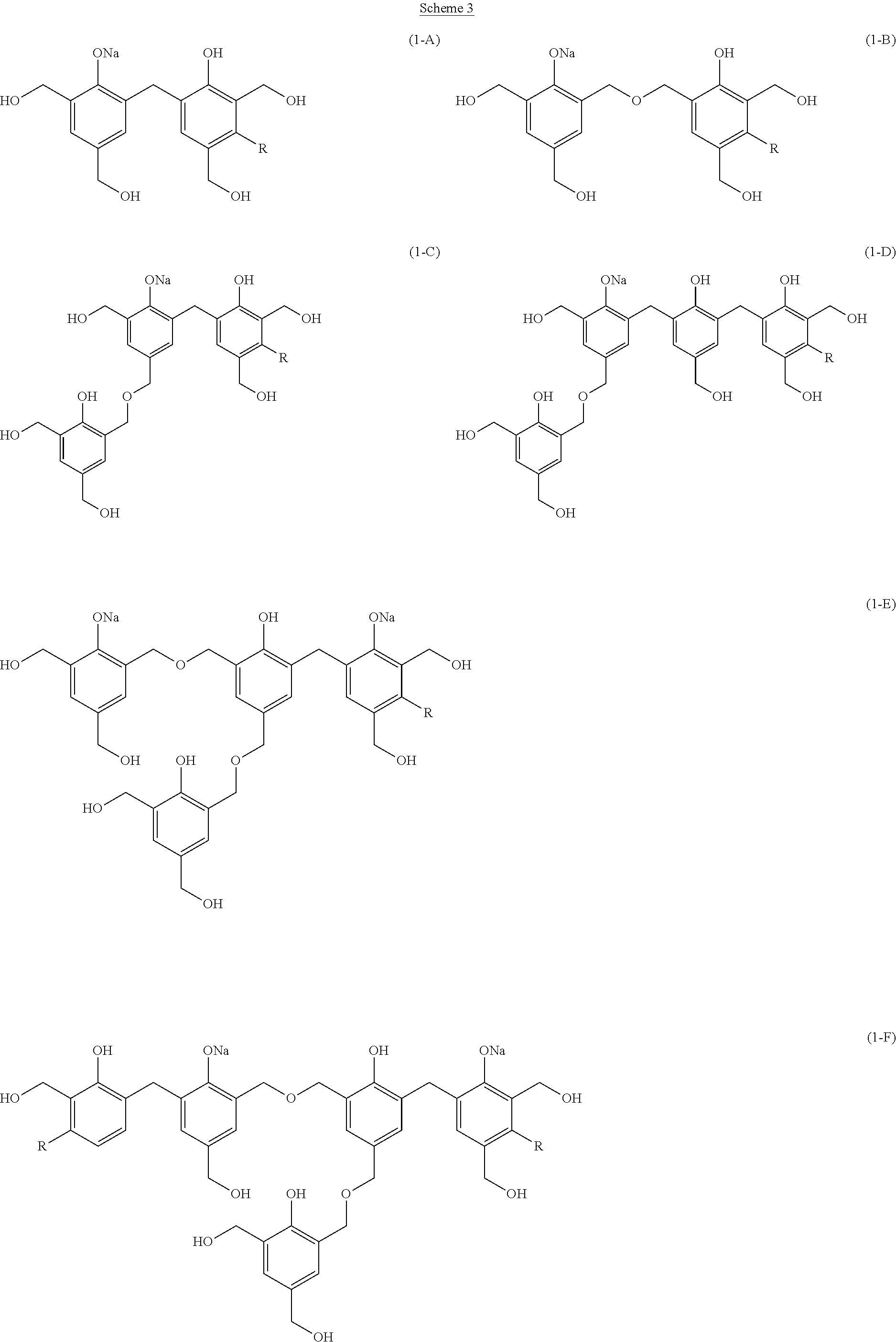

Scheme 4 shows an illustrative, but non-limiting, example of a large and very large polymer represented by Formula (2-A) formed from condensation reactions. These large and very large polymers represented by Formula (2-A), among other large and very large polymers, can make up at least a portion of compositions described herein. In Scheme 4, R is the group shown in Scheme 2, and n is an integer from 1 to 20.

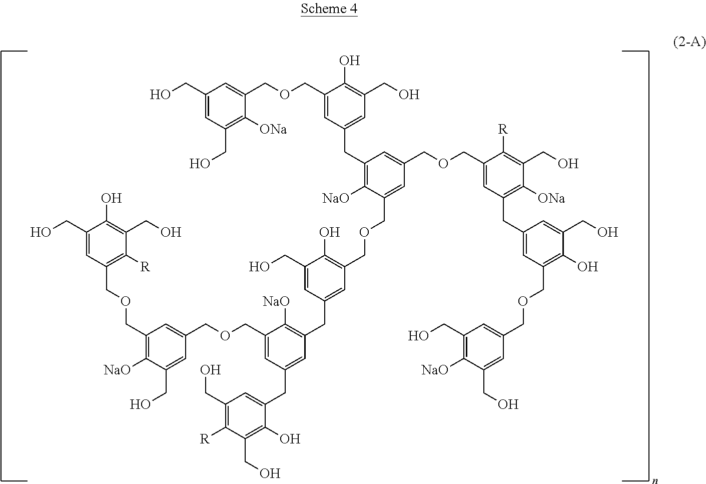

### Example 2: Example Resin Compositions

Table 3 shows a comparison of surface tension for an alkylphenol-phenol-formaldehyde polymer composition as an example embodiment of the present disclosure and a commercial phenol-formaldehyde polymer.

TABLE 3

| | Surface tension, |
|---|---|
| Material | dynes/cm |
| Example alkylphenol-phenol-formaldehyde | 50-54 |
| polymer composition | |
| Commercial phenol-formaldehyde polymer | 65-70 |

Overall, Table 3 indicates that the presence of the alkylphenol in a phenol formaldehyde polymer can reduce the surface tension which allows good resin distribution and surface area coverage of the polymer to a substrate such as a lignocellulosic substrate.

Various example compositions were formed from a mixture of an alkylphenol-phenol-aldehyde polymer composition and a wax emulsion. The alkylphenol-phenol-aldehyde polymer was an alkylphenol-phenol-formaldehyde polymer (APFP) composition.

These compositions were evaluated against a commercial phenol-formaldehyde resin (ME1021RC).

The example compositions are shown in Tables 4A and 4B and include an APFP made with the components listed and 10% lignosulfonate wax emulsion. Example 1-1 includes a APFP made with about 1 wt % cashew nut distillate (CND) and 0 wt % glycerol. Example 1-2 includes an APFP made with about 10% CND and in the presence of about 8 wt % glycerol. Example 1-3 includes an APFP made with about 1 wt % CND and about 3.5 wt % glycerol. Example 1-4 includes a high molecular weight APFP made without glycerol and ˜1% wt (CND) Example 1-5 includes a low molecular weight APFP made without glycerol and about 4.8% (CND). When high CND level is used as in Example 1-5, the production of high molecular weight can be limited due to steric hindrance of the long hydrocarbon chain of the alkylphenol. Example 1-6 includes a blend of 70 wt % of the high molecular weight APFP and 30 wt % of the low molecular weight APFP. The calculated % solids content was measured in accordance with ASTM D4426-01.

TABLE 4A

| | | | | |
|---|---|---|---|---|
| | | Ex. 1-1 | Ex. 1-2 | Ex. 1-3 |
| Material | % conc. | wt % | wt % | wt % |

Alkylphenol-phenol-formaldehyde polymer composition

| | | | | |
|---|---|---|---|---|
| Phenol | 100 | 16.574 | 10.157 | 18.450 |
| Water | 0 | 30.842 | 18.901 | 18.620 |
| Cashew nut distillate (CND) | 98.36 | 0.959 | 9.234 | 0.959 |
| NaOH | 50 | 4.643 | 13.011 | 8.813 |
| Formaldehyde | 50 | 22.600 | 21.825 | 28.452 |
| Glycerol | 80 | 0 | 8.058 | 3.560 |
| Urea | 80 | 14.382 | 8.814 | 11.146 |

Wax emulsion

| | | | | |
|---|---|---|---|---|
| Lignosulfonate slack wax | 47.8 | 10.000 | 10.000 | 10.000 |
| Total, % | — | 100.000 | 100.000 | 100.000 |
| Calculated solids (polymer | — | 42.36 | 50.88 | 49.00 |
| composition), % | | | | |
| Calculated solids (polymer | — | 42.90 | 50.57 | 48.88 |
| composition + wax emulsion), % | | | | |
| Formaldehyde/(Phenol + CND) | — | 2.10 | 2.62 | 2.38 |
| NaOH, % (solids basis) | — | 2.32 | 6.51 | 4.41 |
| CND, % (solids basis) | — | 0.094 | 9.082 | 0.943 |
| Rheology modifier (glycerol), % | — | 0 | 6.446 | 2.848 |
| (solids basis) | | | | |
| Additive (urea), % (solids basis) | — | 11.504 | 7.048 | 8.920 |

TABLE 4B

| | | | | |
|---|---|---|---|---|
| | % | Ex. 1-4 | Ex. 1-5 | Ex. 1-6 |
| Material | Conc. | wt % | wt % | wt % |

Alkylphenol-phenol-formaldehyde polymer composition

| | | | | |
|---|---|---|---|---|
| Phenol | 100 | 16.215 | 15.334 | 15.951 |
| Water | 0 | 18.390 | 19.031 | 18.582 |
| Cashew nut distillate (CND) | 98.36 | 1.031 | 4.372 | 2.034 |
| NaOH | 50 | 13.434 | 12.673 | 13.206 |
| Formaldehyde | 50 | 26.483 | 24.649 | 25.933 |
| Glycerol | 80 | 0 | 0 | 0 |
| Urea | 80 | 14.446 | 13.940 | 14.294 |

Wax emulsion

| | | | | |
|---|---|---|---|---|
| Lignosulfonate slack wax | 47.8 | 10.000 | 10.000 | 10.000 |
| Total, % | — | 100.000 | 100.000 | 100.000 |
| Calculated solids (polymer | — | 48.28 | 49.46 | 48.63 |
| composition), % | | | | |
| Calculated solids (polymer | — | 48.23 | 49.30 | 48.55 |
| composition + wax | | | | |
| emulsion), % | | | | |
| Formaldehyde/(Phenol + CND) | — | 2.51 | 2.31 | 2.45 |
| NaOH, % (solids basis) | — | 6.72 | 6.34 | 6.60 |
| CND, % (solids basis) | — | 1.014 | 4.297 | 2.000 |
| Rheology modifier (glycerol), | — | 0 | 0 | 0 |
| % (solids basis) | | | | |
| Additive (urea), % (solids basis) | — | 11.560 | 11.1525 | 11.432 |

First, various example APFPs were prepared using the components shown in Table 4A and Table 4B. Then, about 10 wt % of the lignosulfonate wax emulsion was added under normal agitation slowly to disperse fully in the APFP. With respect to Example 1-6, the high molecular weight and low molecular weight APFPs were blended and the lignosulfonate wax emulsion was then added under normal agitation slowly to disperse fully in the blend.

Table 5 shows Mn, Mw, and Mz data for selected APFPs of Examples 1-4, 1-5, and 1-6.

TABLE 5

| | Ex 1-4 | Ex 1-5 | Ex 1-6 |
|---|---|---|---|
| Mn (g/mol) | 735 | 237 | 458 |
| Mw (g/mol) | 29440 | 23186 | 34169 |
| Mz (g/mol) | 209307 | 231668 | 256816 |

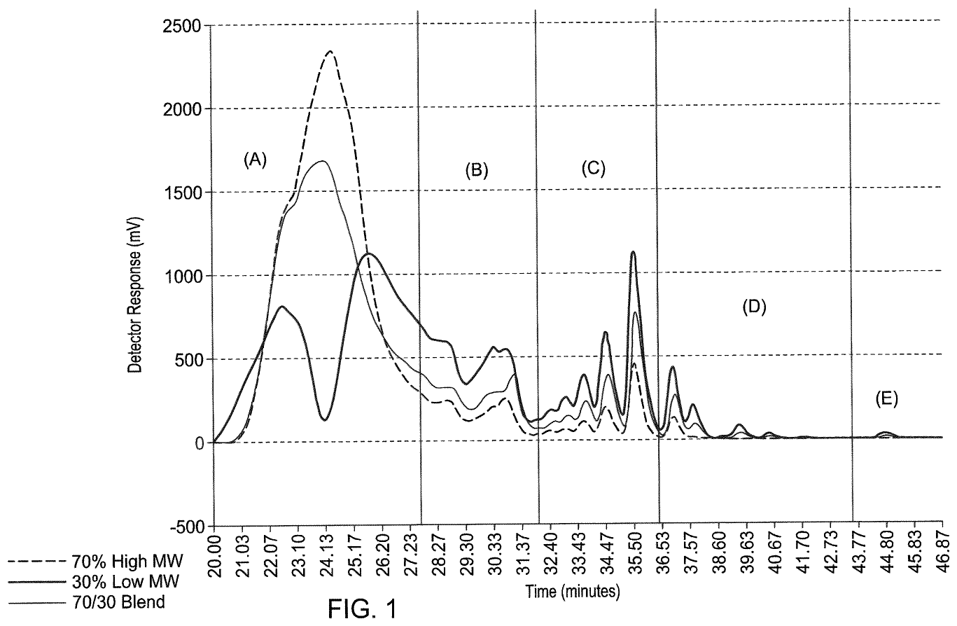

FIG. 1 shows an overlay of GPC chromatograms for the 70/30 blend in black, the high molecular weight APFP composition in blue, and the low molecular weight APFP composition in red. The GPC chromatograms were collected using a ultraviolet (UV) detector. The chromatograms are presented in five parts: Part (A) represents the very large polymers/large polymers such as the polymer represented by Formula (2-A); Part (B) represents the intermediate polymers, Part (C) represents the oligomers (dimers, trimers, and tetramers) such as the oligomers represented by Formulas (I-A), (I-C), and (I-E), Part (D) represents the methylolated phenols such as the phenols represented by Formulas (D), (E), (G), and (I), and Part (E) represents phenol.

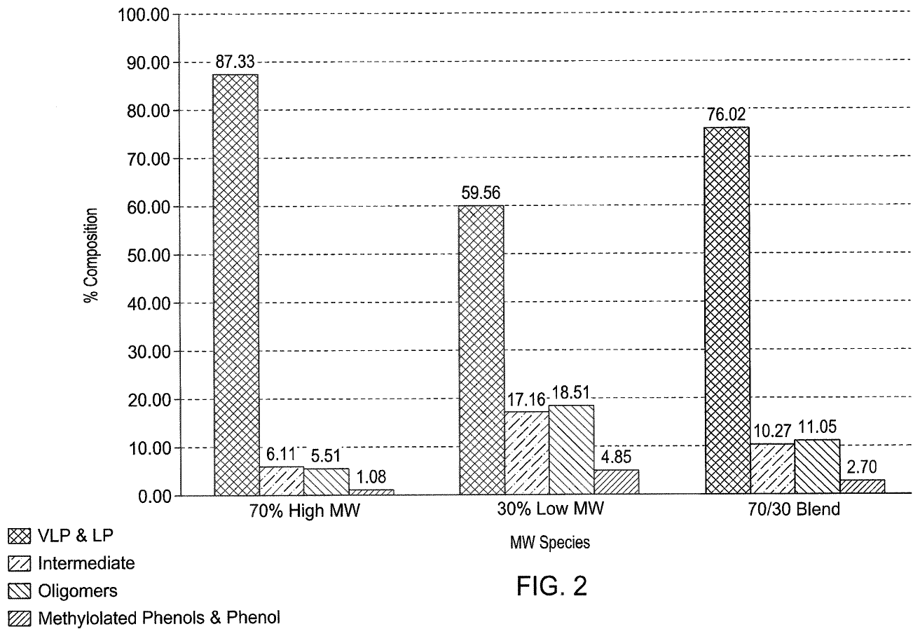

FIG. 2 is a bar chart showing the percent species composition of components (in %) of the 70/30 blend, the high molecular weight APFP composition, and the low molecular weight APFP composition. The % was calculated based on the elution retention time. As shown, the high molecular weight APFP composition included about 87.3% of the very large polymers (VLP)/large polymers (LP), about 6.1% of the intermediate polymers, about 5.5% of the oligomers, and about 1.1% of the methylolated phenols and phenol. The low molecular weight APFP composition included about 59.6% of the VLP and LP, about 17.2% of the intermediate polymers, about 18.5% of the oligomers, and about 4.9% of the methylolated phenols and phenol. The 70/30 blend had a composition that was in between the two, and included about 76% of the VLP and LP, about 10.3% of the intermediate polymers, about 11.1% of the oligomers, and about 2.7% of the methylolated phenols and phenol.

### Example 3: Example Board Making Conditions

The lignocellulosic substrate (Aspen wood), premixed (resin/lignosulfonate wax emulsion) and wax is blended in the blender for top and bottom surface application. Lignocellulosic substrate (Aspen wood), polymeric methylene diphenyl diisocyanate (pMDI), and wax was blended in the blender for core application. After blending, a 24-inch×24-inch oriented strand board (OSB) mat composed of 30% top and bottom surface each side and 40% core was formed. This formed 24-inches×24-inches mat is placed under a steam preheater press for 10 seconds at 92-95° C. dew point then passed to the main press for final curing. Table 6 shows selected parameters for the OSB adhesive and wax application on the lignocellulosic substrate and OSB press parameters.

TABLE 6

| | |
|---|---|
| Parameter | Value |

OSB Adhesive and Wax Application Rate on Wood

| | |
|---|---|
| Premixed resin/lignosulfonate wax | 3.6 (resin) |
| emulsion) top and bottom surface | 0.4 (lignosulfonate |
| application rate on wood, % | wax emulsion) |
| Core (pMDI) application rate on wood, % | 1.8 |
| Wax top and bottom surface application | 0.8-1.0 |
| rate on wood, % | |
| Wax core application rate on wood, % | 0.5-0.65 |
| 100% pMDI surface and core, % | 1.80 |

OSB Press Parameters

| | |
|---|---|
| Wood specimen type | Aspen |
| Board composition, % | 60% surface (APFP); |
| | 40% core (pMDI) |
| Surface mat moisture content after | 7-8 |
| blending with polymer, % | |
| Surface mat moisture content after | 8.5-10.5 |
| steam application, % | |
| Core mat moisture after blending | 4-6 |
| with polymer, % | |
| Board size, inches | 24 × 24 |
| Board thickness, inches | 0.4375 |
| Board density, pounds per cubic foot (pcf) | 37.0 |
| Steam application rate, seconds | 10.0 |
| Dew point, ° C. | 92-95 |
| Time to close to target thickness, seconds | 20 |
| Platen cure temperature, ° C. | 226 |
| Cure time, seconds | 60.0 |
| Degas time before full opening, seconds | 25 |

### Example 4: Application Studies

Several board studies were completed. Selected results are shown in Tables 7A and 7B. Two polymers (Example 1-3 and Example 1-6) were evaluated against pMDI as a control. A commercial phenol-formaldehyde resin (ME1021RC) was used as a comparative example (C.Ex.). Example 1-3 was a low alkaline synthesized with rheology modifier (Glycerol), low CND and is moderately condensed molecular weight polymer. Example 1-6 is a blend of 70% high alkaline, low CND and highly condensed molecular weight with 30% of high alkaline, high CND and moderately condensed molecular weight polymer. OSB mats were prepared as described above. In Tables 7A and 7B, “SP %” refers to adhesive or wax application rate on wood substrate. Percent water absorption (% WA), percent thickness swell (% TS), internal bonding strength, and durability (maximum momentum breaking load) were determined as described above. Group 1 shows the comparative example of 100% pMDI and conventional commercial phenolic resin. Group 2 shows the comparative example of 100% pMDI and low alkaline synthesized with rheology modifier (Glycerol), low CND, and is a moderately condensed molecular weight polymer. Group 3 shows a comparative example of 100% pMDI and a blend of 70% high alkaline, low CND, and highly condensed molecular weight with 30% of high alkaline, high CND and moderately condensed molecular weight polymer. Groups 4-6 are repeated studies of Group 3 to validate results.

TABLE 7A

| | Group 1 | | Group 2 | | Group 3 | |
|---|---|---|---|---|---|---|
| Resin Candidates | pMDI | C. Ex. | pMDI | Ex. 1-3 | pMDI | Ex. 1-6 |
| % wax emulsion | 0 | 0 | 0 | 0.4 | 0 | 0.4 |
| Resin SP % | 1.8 | 3.6 | 1.8 | 3.6 | 1.8 | 3.6 |
| pMDI core SP % | 1.8 | 1.8 | 1.8 | 1.8 | 1.8 | 1.8 |
| Wax surface SP % | 0.8 | 0.8 | 1.0 | 1.0 | 1.0 | 1.0 |
| Wax core SP % | 0.5 | 0.5 | 0.65 | 0.65 | 0.65 | 0.65 |
| Cure time, sec | 60 | 60 | 60 | 60 | 60 | 60 |
| % moisture content after blend | 7.23 | 8.05 | 7.04 | 7.46 | 7.56 | 7.51 |

Measured Properties

| | | | | | | |
|---|---|---|---|---|---|---|
| Internal bonding, psi | 45.17 | 10.61 | 32.81 | 26.82 | 32.22 | 37.8 |
| % WA | 27.16 | 69.12 | 29.42 | 41.81 | 33.67 | 32.99 |
| % TS | 44.13 | 99.04 | 48.32 | 79.62 | 61.86 | 68.94 |
| Maximum momentum breaking | 1,042 | 368 | 1,056 | 946 | 996 | 1088 |
| load, lbf.in | | | | | | |

TABLE 7B

| | Group 4 | | Group 5 | | Group 6 | |
|---|---|---|---|---|---|---|
| Resin Candidates | pMDI | Ex. 1-6 | pMDI | Ex. 1-6 | pMDI | Ex. 1-6 |
| % wax emulsion | 0 | 0.4 | 0 | 0.4 | 0 | 0.4 |
| Resin SP % | 1.8 | 3.6 | 1.8 | 3.6 | 1.8 | 3.6 |
| pMDI core SP % | 1.8 | 1.8 | 1.8 | 1.8 | 1.8 | 1.8 |
| Wax surface SP % | 1.0 | 1.0 | 1.0 | 1.0 | 1.0 | 1.0 |
| Wax core SP % | 0.65 | 0.65 | 0.65 | 0.65 | 0.65 | 0.65 |
| Cure time, sec | 60 | 60 | 60 | 60 | 60 | 60 |
| % moisture content after blend | 7.12 | 7.15 | 7.19 | 7.02 | 7.92 | 8.00 |

Measured Properties

| | | | | | | |
|---|---|---|---|---|---|---|
| Internal bonding, psi | 31.27 | 31.48 | 34.05 | 35.1 | 32.62 | 33.76 |
| % WA | 33.2 | 33.34 | 34.09 | 34.75 | 36.65 | 35.71 |
| % TS | 57.67 | 68.26 | 57.8 | 64.22 | 58.3 | 67.92 |
| Maximum momentum breaking | 1,083 | 1,087 | 976 | 1,059 | 1,066 | 1,069 |
| load, lbf.in | | | | | | |

In Group 1 the conventional commercial phenolic resin underperformed significantly compared to pMDI in all properties. In Group 2 improvement in performance was observed with the alkylphenol-phenol-aldehyde resin plus lignosulfonate wax emulsion compared to the conventional commercial phenolic resin. In Group 3 equal performance to pMDI on internal bonding strength, 24 hours % thickness swelling and durability properties were achieved with alkylphenol-phenol-aldehyde resin plus lignosulfonate wax emulsion. Group 4-6 is a repeat study of Group 3 to validate results.

Groups 3-6 are two blended resin systems of 70% very high advanced molecular weight polymers with 30% moderately advanced and very diverse molecular weight composition polymer. The two blended resin system was able to achieve cure speed with the highly condensed polymer majority component and reactivity with the moderately condensed polymer minority component. The alkylphenol level was also enhanced by blending the two resin system without impacting the degree of condensation to get hydrophobicity and improve the water properties. Group 2 lacks diversification of polymer molecular weight distribution.

### Example 5: Air and Moisture-Barrier OSBs

Air and moisture barrier-oriented strand boards may be used with integrated water resistance paper overlays for wall and roof applications. For such applications, water properties such as 24-hour water absorption and thickness swelling of the final product are relevant.

Various example compositions were formed from a mixture of an alkylphenol-phenol-aldehyde polymer composition and a wax emulsion. The alkylphenol-phenol-aldehyde polymer was APFP composition. These example compositions were evaluated against a commercial phenol-formaldehyde resin. The example compositions and a control made from the commercial phenol aldehyde polymer are shown in Table 8. In Table 8, Ex. 8-1 includes an example APFP, Ex. 8-2 includes a commercial phenol-aldehyde polymer, Ex. 8-3 includes a 50/50 blend of the APFP polymer (Ex. 8-1) and the commercial phenol-aldehyde polymer (Ex. 8-2). Ex. 8-4 is a control (no wax) that includes the commercial phenol aldehyde polymer. The calculated % solids content was measured in accordance with ASTM D4426-01.

TABLE 8

| | | | | | |
|---|---|---|---|---|---|
| | % | Ex. 8-1 | Ex. 8-2 | Ex. 8-3 | Ex. 8-4 |
| Material | conc. | wt % | wt % | wt % | wt % |

Polymer composition

| | | | | | |
|---|---|---|---|---|---|
| Phenol | 100 | 16.458 | 18.185 | 17.322 | 22.320 |
| Water | 0 | 22.004 | 20.371 | 21.187 | 15.888 |
| Cashew nut distillate (CND) | 98.36 | 3.398 | — | 1.969 | — |
| NaOH | 50 | 5.414 | — | 2.707 | 8.000 |
| KOH | 45.5 | — | 8.341 | 4.171 | — |
| Formaldehyde | 50 | 26.486 | 27.952 | 27.217 | 33.604 |
| Glycerol | 80 | 4.922 | 4.356 | 4.639 | 7.500 |
| Urea | 80 | 13.782 | 13.795 | 13.788 | 12.688 |

Wax emulsion

| | | | | | |
|---|---|---|---|---|---|
| Lignosulfonate slack wax | 47.8 | 7.000 | 7.000 | 7.000 | — |
| Total, % | — | 100.000 | 100.000 | 100.000 | 100.000 |
| Calculated solids (polymer composition), % | — | 49.40 | 48.27 | 48.84 | 48.55 |
| Calculated solids (polymer composition + | — | 49.29 | 48.23 | 48.76 | 48.49 |
| wax emulsion), % | | | | | |
| Formaldehyde/(Phenol + CND) | — | 2.35 | 2.41 | 2.38 | 2.36 |
| NaOH, % (solids basis) | — | 2.71 | 0.00 | 1.35 | 4.00 |
| KOH, % (solids basis) | | 0.00 | 3.80 | 1.90 | 0.00 |
| CND, % (solids basis) | — | 3.938 | 0.00 | 1.97 | 0.00 |
| Rheology modifier (glycerol), % (solids basis) | — | 4.922 | 4.356 | 4.64 | 7.50 |
| Additive (urea), % (solids basis) | — | 13.780 | 13.795 | 13.79 | 12.69 |

First, an example APFP and a comparative phenol-aldehyde polymer was made using the components shown in Table 8. The example APFP, comparative phenol-aldehyde polymer, and a 50/50 blend thereof were each mixed with about 7 wt % of the lignosulfonate wax emulsion, adding under normal agitation slowly to disperse fully in the polymer. No wax emulsion was added to Ex. 8-4.

Table 9 shows Mn, Mw, and Mz data for selected APFPs of Examples 8-1, 8-2, 8-3, and 8-4.

TABLE 9

| | Ex. 8-1 | Ex. 8-2 | Ex. 8-3 | Ex. 8-4 |
|---|---|---|---|---|
| Mn (g/mol) | 386 | 439 | 411 | 390 |
| Mw (g/mol) | 11260 | 6114 | 8941 | 2344 |
| Mz (g/mol) | 45928 | 19617 | 37600 | 7242 |

A lignocellulosic substrate (southern Yellow Pine), premixed (resin/lignosulfonate wax emulsion) and wax is blended in the blender for top and bottom surface application. Lignocellulosic substrate, polymeric methylene diphenyl diisocyanate (pMDI), and wax was blended in the blender for core application. After blending, a 24-inch×24-inch oriented strand board (OSB) mat composed of 32.5% top and bottom surface each side and 35% core was formed. This formed 24-inches×24-inches mat is placed under a a platen at 226° C. to target thickness of 0.4375 inches and pressed for 60 seconds to cure. Table 10 shows selected parameters for the OSB adhesive and wax application on the lignocellulosic substrate and OSB press parameters.

TABLE 10

| | |
|---|---|
| Parameter | Value |

OSB Adhesive and Wax Application Rate on Wood

| | |
|---|---|
| Premixed resin/lignosulfonate wax | 3.6-6.25 (resin) |
| emulsion) top and bottom surface | 0.00-0.50 |
| application rate on wood, % | (lignosulfonate wax |
| | emulsion) |
| Core (pMDI) application rate on wood, % | 3.00 |
| Wax top and bottom surface application | 0.5-1.0 |
| rate on wood, % | |
| Wax core application rate on wood, % | 0.5-1.00 |
| 100% pMDI surface and core, % | 3.00 |

OSB Press Parameters

| | |
|---|---|
| Wood specimen type | SYP (southern |
| | Yellow Pine) |
| Board composition, % | 65% surface (APFP); |
| | 35% core (pMDI) |
| Surface mat moisture content after | 7-8 |
| blending with polymer, % | |
| Core mat moisture after blending with | 4-6 |
| polymer, % | |
| Board size, inches | 24 × 24 |
| Board thickness, inches | 0.4375 |
| Board density, pounds per cubic foot (pcf) | 45.00 |
| Time to close to target thickness, seconds | 20 |
| Platen cure temperature, ° C. | 226 |
| Cure time, seconds | 65.0 |
| Degas time before full opening, seconds | 22 |

Several board studies were completed. Selected results are shown in Table 11. Ex. 8-3 includes a 50/50 blend of the APFP polymer (Ex. 8-1) and the commercial phenol-aldehyde polymer (Ex. 8-2). An APFP (Example 8-3) was evaluated against pMDI as a control. Ex. 8-4 is a control (no wax) that includes the commercial phenol aldehyde polymer. OSB mats were prepared as described above. In Table 11, “SP %” refers to adhesive or wax application rate on wood substrate. Percent water absorption (% WA) and percent thickness swell (% TS) were determined as described above.

TABLE 11

| Resin Candidates | pMDI | Ex. 8-3 | Ex. 8-4 |
|---|---|---|---|
| % Lignosulfonate wax emulsion | 0.00 | 0.471 | 0.00 |
| Resin SP % | 3.00 | 6.25 | 6.25 |
| pMDI core SP % | 3.00 | 3.00 | 3.00 |
| Wax surface SP % | 0.58 | 0.58 | 0.58 |
| Wax core SP % | 0.64 | 0.64 | 0.64 |
| Cure time, sec | 60 | 60 | 60 |
| % moisture content after blend | 6.90 | 8.43 | 8.24 |
| Wood Species | SYP | SYP | SYP |

Measured Properties

| | | | |
|---|---|---|---|
| % WA | 34.87 | 35.73 | 43.35 |
| % TS | 21.14 | 21.01 | 24.58 |

The OSB made with the resin of Ex. 8-3 was determined to have similar performance to pMDI with respect to % water absorption and 24 hours % thickness swelling, though the % thickness swelling was improved relative to pMDI. The OSB made with the resin of Ex. 8-3 was determined to significantly outperform the conventional phenol-aldehyde polymer resin of Ex. 8-4 with respect to both % water absorption and 24 hours % thickness swelling. Overall, the data indicated that, resin compositions including a phenolic resin, an APFP polymer, and a wax emulsion can be utilized for moisture barrier application without loss on final panel water properties.

Embodiments of the present disclosure generally relate to phenolic resin compositions, methods for preparing the same, and uses thereof. As described herein, the alkylphenol-phenol-aldehyde polymer of compositions of the present disclosure can be designed with a specific molecular weight species for use in a continuous steam application process. In some embodiments, this can entail a reduction of the smaller molecular weight mostly the methylolated phenols and increased oligomers and intermediate polymers and moderately advanced large and very large polymers. As also described herein, the wax emulsion can be incorporated with the polymer to improve the water properties without impacting bonding and durability of the finished board. In addition, rheology modifiers can be incorporated to partially replace formula water to increase solids for better heat transfer during panel making and also improve resin flow & penetration when applied to the substrate.

A combination of monomer substitution, molecular weight distribution, and chemical additives can be utilized to overcome the impact of steam on the cure of phenolic resins resulting in no loss of production time or final panel performance. The substitution of a portion of phenol with an alkylphenol can be used to aid in the development of a desired molecular weight distribution. The alkyl chain provided by an alkylphenol is hydrophobic in nature and can provide hydrophobicity and flexibility to the finished resin. The molecular weight distribution of the polymer can be controlled by the order of addition of reactants and condensation methods which led to less low molecular weight species which may not be beneficial to resin performance under steam preheat conditions. The addition of a wax emulsion was used to further increase moisture resistance. The use of specific surfactants aid in resin distribution and penetration control on the wood substrate.

The resin compositions described herein can have a high solids content, a high alkalinity, high molecular weight, or combinations thereof. Such properties can enable faster cure speeds than conventional phenol-aldehyde resins. In addition, lignocellulosic composite materials fabricated with the resin compositions described herein can have improved mechanical properties relative to conventional technologies. Furthermore, the resin compositions are capable of producing lignocellulosic composite products with superior water absorption and thickness swell test results, making the composite products more water resistant and durable relative to conventional composite products.

### EMBODIMENTS LISTING

The present disclosure provides, among others, the following aspects, each of which can be considered as optionally including any alternate embodiments:

Clause 1. A resin composition, comprising:
a wax emulsion; and
a polymer composition comprising an alkylphenol-phenol-aldehyde polymer, the alkylphenol-phenol-aldehyde polymer comprising:
   alkylphenol monomer units, the alkylphenol monomer units represented by Formula (I):

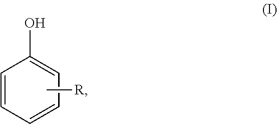

wherein R is an unsubstituted hydrocarbyl having from 1 to 40 carbon atoms or a substituted hydrocarbyl having from 1 to 40 carbon atoms; and
phenol compound co-monomer units.

Clause 2. The resin composition of Clause 1, wherein: the alkylphenol monomer units comprises cardanol, cresol, xylenol, ethyl phenol, alkyl resorcinol, isomers thereof, or combinations thereof; and the phenol compound co-monomer units comprise phenol, resorcinol, or combinations thereof.

Clause 3. The resin composition of Clause 1 or Clause 2, wherein the wax emulsion comprises: a petroleum-based wax, a coal-derived wax, a synthetic wax, a bio-based wax, or combinations thereof; and an emulsifier comprising an alkali metal hydroxide, a surfactant, an ionic dispersant, or combinations thereof.

Clause 4. The resin composition of any one of Clauses 1-3, wherein the wax emulsion comprises a lignosulfonate slack wax.

Clause 5. The resin composition of any one of Clauses 1-4, wherein: R of Formula (I) is meta to the hydroxyl (—OH) group; and R of Formula (I) is C₁₅H₃₀₋ₙ and n is 0, 2, 4, or 6.

Clause 6. The resin composition of any one of Clauses 1-5, wherein the alkylphenol-phenol-aldehyde polymer comprises: a high molecular weight component and a low molecular weight component; from about 50% to about 90% of the high molecular weight component based on a total % of very large polymers, large polymers, intermediate polymers, oligomers, methylolated phenols, and phenol present in the alkylphenol-phenol-aldehyde polymer, the total % not to exceed 100%; and from about 1% to about 20% of the low molecular weight component based on the total %.

Clause 7. The resin composition of any one of Clauses 1-6, wherein the alkylphenol-phenol-aldehyde polymer has: a number average molecular weight (Mn) value that is from about 200 g/mol to about 800 g/mol; a weight average molecular weight (Mw) that is from about 20,000 g/mol to about 40,000 g/mol; and a z-average molecular weight (Mz) that is from about 200,000 g/mol to about 300,000 g/mol.

Clause 8. The resin composition of any one of Clauses 1-7, wherein the alkylphenol-phenol-aldehyde polymer comprises: from greater than 0 wt % to about 12 wt % of the alkylphenol monomer units based on a total wt % of the alkylphenol monomer units and the phenol compound co-monomer units, the total wt % of the alkylphenol monomer units and the phenol compound co-monomer units not to exceed 100 wt %; and from about 88 wt % to less than 100 wt % of phenol monomer units based on the total wt % of the alkylphenol monomer units and the phenol compound co-monomer units.

Clause 9. The resin composition of any one of Clauses 1-8, further comprising a rheology modifier, a surfactant, or combinations thereof.

Clause 10. The resin composition of Clause 9, wherein the rheology modifier comprises a polyhydric alcohol.

Clause 11. The resin composition of Clause 10, wherein the polyhydric alcohol comprises glycerol, crude glycerin, refined glycerin, ethylene glycol, diethylene glycol, propylene glycol, propane-1,2,3-triol, propanetriol, 1,2,3-trihydroxypropane, 1,2,3-propanetriol, or combinations thereof.

Clause 12. The resin composition of Clause 10 or Clause 11, wherein the polyhydric alcohol comprises glycerol.

Clause 13. The resin composition of any one of Clauses 1-12, further comprising water.

Clause 14. The resin composition of any one of Clauses 1-13, wherein the resin composition comprises: about 70 wt % or more of the alkylphenol-phenol-aldehyde polymer based on a total wt % of the resin composition, the total wt % of the resin composition not to exceed 100 wt %; and from greater than 0 wt % to about 30 wt % of the wax emulsion based on the total wt % of the resin composition.

Clause 15. The resin composition of any one of Clauses 1-14, wherein the resin composition comprises: from greater than 0 wt % to about 13 wt % of the wax emulsion based on a total wt % of the resin composition.

Clause 16. A resin composition, comprising:
a wax emulsion; and
a polymer composition comprising a condensation product of a reaction mixture comprising: an alkylphenol compound; a phenol compound; an aldehyde; a base; a polyhydric alcohol; and a solvent.

Clause 17. The resin composition of Clause 16, wherein the resin composition comprises from greater than 0 wt % to about 13 wt % of the wax emulsion based on a total wt % of the resin composition.

Clause 18. The resin composition of Clause 16 or Clause 17, wherein the polymer composition comprises: from about 10 wt % to about 25 wt % of the alkylphenol compound plus the phenol compound based on a total wt % of the polymer composition, the total wt % of the polymer composition not to exceed 100 wt %; from about 5 wt % to about 10 wt % of the aldehyde based on the total wt % of the polymer composition; from about 2.5 wt % to about 8 wt % of the base based on the total wt % of the polymer composition; from greater than 0 to about 12 wt % of the polyhydric alcohol based on the total wt % of the polymer composition; and from about 45 wt % to about 58 wt % of the solvent based on the total wt % of the polymer composition.

Clause 19. The resin composition of any one of Clauses 17-19, wherein the alkylphenol-phenol-aldehyde polymer comprises: from greater than 0 wt % to about 12 wt % of the alkylphenol compound based on a total wt % of the alkylphenol compound and the phenol compound, the total wt % of the alkylphenol compound and the phenol compound not to exceed 100 wt %; from about 88 wt % to less than 100 wt % of the phenol compound based on the total wt % of the alkylphenol compound and the phenol compound; a molar ratio of the aldehyde to a total amount of the alkylphenol compound plus the phenol compound that is from about 2:1 to about 2.6:1; or combinations thereof.

Clause 20. A curable resin composition, comprising:
a wax emulsion described herein; and
a reaction product of: a phenol compound; formaldehyde; and an alkylphenol having from 1 to 40 carbon atoms in an alkyl group of the alkylphenol, wherein a molar ratio of the formaldehyde to total amount of the phenol and the alkylphenol is from about 2:1 to about 2.6:1.

Clause 21. A curable resin composition of claim 16, wherein: the alkylphenol comprises cardanol, cresol, xylenol, ethyl phenol, alkyl resorcinol, isomers thereof, or combinations thereof; and the phenol compound comprises phenol, resorcinol, or combinations thereof.

Clause 22. An article of manufacture, comprising:
a lignocellulosic substrate; and
a resin composition comprising:
   an alkylphenol-phenol-aldehyde polymer described herein;
   a polyhydric alcohol described herein; and
   a wax emulsion described herein.

Clause 23. A resin composition, comprising:
a lignosulfonate wax emulsion described herein;
a phenolic resin described herein; and
a polymer composition comprising an alkylphenol-phenol-aldehyde polymer described herein.

Clause 24. An article of manufacture, comprising:
a lignocellulosic substrate described herein; and
a resin composition comprising:
   an alkylphenol-phenol-aldehyde polymer described herein;
   a phenolic resin described herein; and
   a wax emulsion described herein.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a polymer composition” include aspects comprising one, two, or more polymer compositions, unless specified to the contrary or the context clearly indicates only one polymer composition is included.

While the foregoing is directed to aspects of the present disclosure, other and further aspects of the disclosure may be devised without departing from the basic scope thereof, and the scope thereof is determined by the claims that follow.

What is claimed is:

1. A resin composition, comprising:
a wax emulsion; and
a polymer composition comprising an alkylphenol-phenol-aldehyde polymer, the alkylphenol-phenol-aldehyde polymer comprising:
alkylphenol monomer units, the alkylphenol monomer units represented by Formula (I): 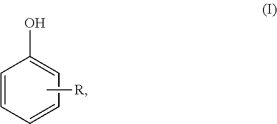
wherein R is an unsubstituted hydrocarbyl having from 1 to 40 carbon atoms or a substituted hydrocarbyl having from 1 to 40 carbon atoms; and
phenol compound co-monomer units.

2. A resin composition of claim 1, wherein:
the alkylphenol monomer units comprises cardanol, cresol, xylenol, ethyl phenol, alkyl resorcinol, isomers thereof, or combinations thereof; and
the phenol compound co-monomer units comprise phenol, resorcinol, or combinations thereof.

3. A resin composition of claim 1, wherein the wax emulsion comprises:
a petroleum-based wax, a coal-derived wax, a synthetic wax, a bio-based wax, or combinations thereof; and
an emulsifier comprising an alkali metal hydroxide, a surfactant, an ionic dispersant, or combinations thereof.

4. A resin composition of claim 3, wherein the wax emulsion comprises a lignosulfonate slack wax.

5. A resin composition of claim 1, wherein:
R of Formula (I) is meta to the hydroxyl (—OH) group; and
R of Formula (I) is C₁₅H₃₀₋ₙ wherein n is 0, 2, 4, or 6.

6. A resin composition of claim 1, wherein the alkylphenol-phenol-aldehyde polymer comprises:
a high molecular weight component and a low molecular weight component;
from about 50% to about 90% of the high molecular weight component based on a total % of very large polymers, large polymers, intermediate polymers, oligomers, methylolated phenols, and phenol present in the alkylphenol-phenol-aldehyde polymer, the total % not to exceed 100%; and
from about 1% to about 20% of the low molecular weight component based on the total %.

7. A resin composition of claim 1, wherein the alkylphenol-phenol-aldehyde polymer has:
a number average molecular weight (Mn) value that is from about 200 g/mol to about 800 g/mol;
a weight-average molecular weight (Mw) that is from about 20,000 g/mol to about 40,000 g/mol; and
a z-average molecular weight that is from about 200,000 g/mol to about 300,000 g/mol.

8. A resin composition of claim 1, wherein the alkylphenol-phenol-aldehyde polymer comprises:
from greater than 0 wt % to about 12 wt % of the alkylphenol monomer units based on a total wt % of the alkylphenol monomer units and the phenol compound co-monomer units, the total wt % of the alkylphenol monomer units and the phenol compound co-monomer units not to exceed 100 wt %; and
from about 88 wt % to less than 100 wt % of phenol monomer units based on the total wt % of the alkylphenol monomer units and the phenol compound co-monomer units.

9. A resin composition of claim 1, further comprising a rheology modifier, a surfactant, or combinations thereof.

10. A resin composition of claim 9, wherein the rheology modifier comprises a polyhydric alcohol.

11. A resin composition of claim 10, wherein the polyhydric alcohol comprises glycerol, crude glycerin, refined glycerin, ethylene glycol, diethylene glycol, propylene glycol, propane-1,2,3-triol, propanetriol, 1,2,3-trihydroxypropane, 1,2,3-propanetriol, or combinations thereof.

12. A resin composition of claim 10, wherein the polyhydric alcohol comprises glycerol.

13. A resin composition of claim 1, further comprising water.

14. A resin composition of claim 1, wherein the resin composition comprises:
about 70 wt % or more of the alkylphenol-phenol-aldehyde polymer based on a total wt % of the resin composition, the total wt % of the resin composition not to exceed 100 wt %; and
from greater than 0 wt % to about 30 wt % of the wax emulsion based on the total wt % of the resin composition.

15. A resin composition of claim 1, wherein the resin composition comprises:
from greater than 0 wt % to about 13 wt % of the wax emulsion based on a total wt % of the resin composition.

16. A curable resin composition, comprising:
a wax emulsion; and
a reaction product of:
a phenol compound;
formaldehyde; and
an alkylphenol having from 1 to 40 carbon atoms in an alkyl group of the alkylphenol;
wherein:
a molar ratio of the formaldehyde to total amount of the phenol and the alkylphenol is from about 2:1 to about 2.6:1.

17. A curable resin composition of claim 16, wherein:
the alkylphenol comprises cardanol, cresol, xylenol, ethyl phenol, alkyl resorcinol, isomers thereof, or combinations thereof; and
the phenol compound comprises phenol, resorcinol, or combinations thereof.

18. An article of manufacture, comprising:
a lignocellulosic substrate; and
a resin composition comprising:
an alkylphenol-phenol-aldehyde polymer;
a polyhydric alcohol; and
a wax emulsion.

19. A resin composition, comprising:
a wax emulsion;
a phenolic resin; and
a polymer composition comprising an alkylphenol-phenol-aldehyde polymer.

20. An article of manufacture, comprising:
a lignocellulosic substrate; and
a resin composition comprising:
an alkylphenol-phenol-aldehyde polymer;
a phenolic resin; and
a wax emulsion.
